(19) United States
(12) Patent Application Publication
(10) Pub. No.: US 2019/0292436 A1
(43) Pub. Date: Sep. 26, 2019

(54) Chlorine Dioxide Containing Mixtures And Chlorine Dioxide Bulk Treatments For Enhancing Oil And Gas Recovery

(71) Applicant: Sabre Intellectual Property Holdings LLC, Slingerlands, NY (US)

(72) Inventors: John Y. Mason, Slingerlands, NY (US); Madeline C. Bette, Loudonville, NY (US); Kevin M. Bette, Loudonville, NY (US)

(21) Appl. No.: 16/063,680

(22) PCT Filed: Dec. 16, 2016
(86) PCT No.: PCT/US2016/067251

§ 371 Date: Jun. 18, 2018

Related U.S. Application Data
(60) Provisional application No. 62/269,817, filed on Dec. 18, 2015.

(51) Int. Cl. C09K 8/58; C09K 8/86; C09K 8/84; E21B 37/06; E21B 43/16

(52) U.S. Cl. CPC C09K 8/58; C09K 8/86; E21B 43/267; E21B 37/06; E21B 43/164; C09K 8/845

(57) ABSTRACT

The present disclosure provides a bulk treatment for introduction into a hydrocarbon bearing formation, the bulk treatment comprising a volume of a treatment fluid comprising chlorine dioxide, wherein the volume is such that when the treatment fluid is introduced into a wellbore that penetrates the hydrocarbon bearing formation, the fluid is expected to extend into the formation to a radius that goes beyond the near wellbore region. Such a bulk treatment can act to draw out hydrocarbons from a hydrocarbon-bearing formation, thereby enhancing recovery of oil and/or gas. Also provided herein are mixtures comprising chlorine dioxide, water, an organic non-polar solvent, and optionally one or more additional components (e.g., an acid or chelating agent and/or a surfactant or cosolvent). The mixtures are useful for enhancing recovery of oil and/or gas and for removing residues that contain hydrocarbons. Apparatus for making the mixtures, and methods of making and using the mixtures, e.g., to mitigate damage and/or enhance recovery of oil and/or gas from a petroleum well, are also disclosed.

### RELATED APPLICATIONS

This application claims priority to U.S. Patent Application No. 62/269,817 filed on Dec. 18, 2015, the entire contents of which are hereby incorporated herein by reference.

### BACKGROUND

After operating for some time, a production well in the petroleum industry (e.g., a well from which crude oil and/or gas is extracted) typically shows a decline in production. The production decline can be caused by depletion of petroleum in the formation in which the well is located. However, declines in production can also occur before the petroleum is actually depleted, due to other causes such as an undesired buildup of residue, which is generally known in the petroleum industry as “damage.” The damage affects the wellbore or near-wellbore region and forms a “skin” known as “skin damage.” Such damage can arise from buildup of various particles, fluids, and/or contaminants (e.g., bacteria or biomass). Damage can restrict the permeability of the wellbore and near-wellbore region to the flow of oil and/or gas, thus contributing to declining production.

Various well treatment techniques have been used in an attempt to remove damage, mitigate declining production, and/or enhance crude oil recovery. Among numerous other types of well treatment techniques, chlorine dioxide dissolved in water has previously been introduced into wells because it is known that chlorine dioxide can oxidize and thereby remove or partially remove damage within a wellbore and the immediately surrounding near-wellbore region.

As exemplified herein, Applicant has unexpectedly found that chlorine dioxide works not only to mitigate damage but also can actively draw out hydrocarbons from solid materials including hydrocarbon-bearing geologic formations. Based on this finding, Applicant has developed methods of well treatment in which a large volume of chlorine dioxide treatment fluid is employed to target areas of a hydrocarbon-bearing formation extending beyond the near wellbore region. Such treatments draw out hydrocarbons from regions of the formation remote from the wellbore itself, thereby dramatically enhancing recovery of crude oil and/or natural gas.

Additionally, Applicant has developed fluid mixtures that include water, one or more organic solvents, and chlorine dioxide; methods of making and using the mixtures; and apparatus for making the mixtures. The mixtures can be employed advantageously for various applications in the petroleum industry, including to remove damage or mitigate the effects of damage, to improve permeability, to mitigate declining production, and/or to enhance recovery of crude oil and/or natural gas.

### SUMMARY

Disclosed herein is a mixture comprising a) water, b) chlorine dioxide at a concentration of at least 100 ppm and c) an organic non-polar solvent. Typically, the mixture is for use as disclosed herein, e.g., for introduction into a wellbore. In some embodiments, the mixture is homogeneous and/or produced using a venturi.

In some embodiments, the chlorine dioxide is at a concentration of at least 200 ppm. In some embodiments, the chlorine dioxide is at a concentration of at least 500 ppm. In some embodiments, the chlorine dioxide is at a concentration of at least 1000 ppm.

In some embodiments, the mixture comprises the non-polar organic solvent at a concentration of at least 0.5%, 1%, 2%, 3%, 4%, or 5%.

In some embodiments, the organic non-polar solvent is at a concentration of up to 20%. In some embodiments, the mixture further comprises d) an acid or a chelating agent at a concentration of up to 20%.

In some embodiments, the acid or chelating agent comprises acetic acid, carbonic acid, citric acid, ethylenediaminetetraacetic acid (EDTA), glycolic acid (hydroxyacetic acid), gluconic acid, hydrochloric acid, hydrofluoric acid, nitric acid, nitrilotriacetic acid (NTA), phosphoric acid, sulfuric acid or tartaric acid. The acid or chelating agent can include any two or more of the foregoing listed acids or chelating agents.

In some embodiments, the acid or chelating agent is selected from the group consisting of acetic acid, carbonic acid, citric acid, ethylenediaminetetraacetic acid (EDTA), glycolic acid (hydroxyacetic acid), gluconic acid, hydrochloric acid, hydrofluoric acid, nitric acid, nitrilotriacetic acid (NTA), phosphoric acid, sulfuric acid, and tartaric acid.

In some embodiments, the acid or chelating agent is citric acid.

In some embodiments, the mixture is homogenous.

In some embodiments, the mixture does not show significant separation when pumped at a velocity of at least about 50 feet per minute (about 15 meters per minute).

In some embodiments, the mixture is effective to diminish damage. In some embodiments, the mixture is effective to diminish damage in a well when it is injected into the well.

In some embodiments, the mixture the chlorine dioxide is at a concentration of 1000 to 20,000 ppm. In some embodiments, the chlorine dioxide is at a concentration of 1000 to 6000 ppm.

In some embodiments, the water comprises a salt. In some embodiments, the water comprises salt at a concentration of 0.1 to 7%. In some embodiments, the salt comprises potassium chloride, sodium chloride, calcium chloride, potassium bromide, sodium bromide, calcium bromide, zinc bromide, ammonium chloride, potassium phosphate, sodium formate, potassium formate, cesium formate, ethyl formate, methyl formate, methyl chloro formate, triethyl orthoformate, or trimethyl orthoformate. The salt can include two or more of the foregoing listed salts.

In some embodiments, the water comprises a salt selected from the group consisting of potassium chloride, sodium chloride, calcium chloride, potassium bromide, sodium bromide, calcium bromide, zinc bromide, ammonium chloride, potassium phosphate, sodium formate, potassium formate, cesium formate, ethyl formate, methyl formate, methyl chloro formate, triethyl orthoformate, and trimethyl orthoformate. In some embodiments, the salt is potassium chloride.

In some embodiments, the mixture further comprises up to 5% of a surfactant or cosolvent.

In some embodiments, the surfactant or cosolvent is an organoether.

In some embodiments, the organoether comprises ethylene glycol monobutyl ether (EGMBE). In some embodiments, the organoether is ethylene glycol monobutyl ether (EGMBE).

In some embodiments, the organic non-polar solvent comprises benzene, cyclohexane, cyclopentane, diesel fuel, ethylbenzene, trimethylbenzene, hexane, heptane, kerosene, pentane, toluene, or xylene. The organic non-polar solvent can include any two or more of the foregoing listed organic non-polar solvents.

In some embodiments, the organic non-polar solvent is selected from the group consisting of benzene, cyclohexane, cyclopentane, diesel fuel, ethylbenzene, trimethylbenzene, hexane, heptane, kerosene, pentane, toluene, and xylene.

In some embodiments, the organic non-polar solvent has a flash point of at least 5° C.

In some embodiments, some or all components of the mixture travel through a venturi.

In some embodiments, the mixture is produced using venturi mixing. In some embodiments, at least the water, the chlorine dioxide, and the organic non-polar solvent are venturi mixed.

In some embodiments, the mixture is produced using a chlorine dioxide generator comprising a venturi.

Also disclosed herein is a mixture comprising a) water (e.g., water comprising 0.1-7% of a salt), b) chlorine dioxide at a concentration of 1000-6000 ppm, c) 1-10% of an organic non-polar solvent, and d) 0.1-10% of an acid or chelating agent.

In some embodiments, the salt comprises potassium chloride.

In some embodiments, the salt is potassium chloride.

In some embodiments, the chlorine dioxide is at a concentration of 2500-3500 ppm.

In some embodiments, the organic non-polar solvent comprises xylene.

In some embodiments, the organic non-polar solvent is xylene.

In some embodiments, the acid or chelating agent comprises citric acid.

In some embodiments, the acid or chelating agent is citric acid.

In some embodiments, the mixture further comprises a surfactant or cosolvent at a concentration of 0.1 to 5%. In some embodiments, the surfactant or cosolvent comprises an organoether (e.g., EGMBE).

In some embodiments, the mixture further comprises EGMBE at a concentration of 0.1 to 5%.

In some embodiments, the salt is at a concentration of about 2%.

In some embodiments, the organic non-polar solvent is at a concentration of 2 to 7%.

In some embodiments, the organic non-polar solvent is at a concentration of 2.5 to 5%.

In some embodiments, the organic non-polar solvent is at a concentration of about 5%.

In some embodiments, the acid or chelating agent is at a concentration of about 2%.

In another aspect provided herein is a method of making a mixture, the method comprising (i) venturi mixing a first component and a second component and, concurrently or subsequently, (ii) venturi mixing a third component with the first and/or second component, wherein the first component, the second component and the third component are different and selected from water, chlorine dioxide and organic non-polar solvent. In some embodiments, step (i) is performed before step (ii). In some embodiments, at least the first and second components are venturi mixed before all three components are mixed (e.g., before all three components are venturi mixed). The mixture, and the method of making the mixture, can have other components, steps or features disclosed herein.

Also disclosed herein is a method of making a mixture, the method comprising educting into a venturi that uses water (e.g., water comprising 0.1-7% of a salt) as its drive fluid (i) chlorine dioxide and

(ii) an organic non-polar solvent, and optionally (iii) an acid or chelating agent, and/or (iv) a surfactant or cosolvent; thereby forming a mixture comprising the water, the chlorine dioxide, and the organic solvent, and optionally the acid or chelating agent and/or the surfactant or cosolvent. In some embodiments, the chlorine dioxide is at a concentration of at least 100 ppm. In some embodiments, the chlorine dioxide is at a concentration of at least 200 ppm. In some embodiments, the chlorine dioxide is at a concentration of at least 500 ppm. In some embodiments, the chlorine dioxide is at a concentration of at least 1000 ppm. In some embodiments, the chlorine dioxide is at a concentration of at least 2000 ppm.

In some embodiments, the organic non-polar solvent is at a concentration of 1-20%.

In some embodiments, the mixture comprises an acid or chelating agent at a concentration of 0.1-20%.

In some embodiments, the mixture comprises a surfactant or cosolvent at a concentration of 0.1-5%.

In some embodiments, the mixture comprises the chlorine dioxide at a concentration of at least 100, 200, or 500 ppm, the organic non-polar solvent at a concentration of 1-20%, and optionally the acid or chelating agent at a concentration of 0.1-20% and/or the surfactant or cosolvent at a concentration of 0.1-5%.

In some embodiments, the mixture comprises the chlorine dioxide at a concentration of at least 1000 ppm, the organic non-polar solvent at a concentration of 1-20%, and optionally the acid or chelating agent at a concentration of 0.1-20% and/or the surfactant or cosolvent at a concentration of 0.1-5%.

Also disclosed herein is a method of making a mixture, the method comprising educting into a venturi that uses an organic non-polar solvent as its drive fluid (i) chlorine dioxide and (ii) water (e.g., water comprising 0.1-7% of a salt), and optionally (iii) an acid or chelating agent and/or (iv) a surfactant or cosolvent; thereby forming a mixture comprising the organic non-polar solvent, the chlorine dioxide, and the water, and optionally the acid or chelating agent and/or the surfactant or cosolvent. In some embodiments, the chlorine dioxide is at a concentration of at least 100 ppm. In some embodiments, the chlorine dioxide is at a concentration of at least 200 ppm. In some embodiments, the chlorine dioxide is at a concentration of at least 500 ppm. In some embodiments, the chlorine dioxide is at a concentration of at least 1000 ppm. In some embodiments, the chlorine dioxide is at a concentration of at least 2000 ppm.

In some embodiments, the water is at a concentration of 1-20% in the mixture.

In some embodiments, the mixture comprises an acid or chelating agent at a concentration of 0.1-20%.

In some embodiments, the mixture comprises a surfactant or cosolvent at a concentration of 0.1-5%.

In some embodiments, the mixture comprises the chlorine dioxide at a concentration of at least 1000 ppm and the water at a concentration of 1-20%, and optionally the acid or chelating agent at a concentration of 0.1-20% and/or the surfactant or cosolvent at a concentration of 0.1-5%.

Also provided herein is a mixture made according to a method disclosed herein.

Also disclosed herein is a method of treating a well, the method comprising introducing a mixture disclosed herein into the wellbore of the well.

In some embodiments, the mixture is homogeneous (e.g., it exhibits temporary homogeneity). In some embodiments, the method further comprises agitating the mixture (e.g., by applying energy to stir, pump, or move the mixture) such that it remains homogeneous prior to its introduction into the wellbore. In some embodiments, the method further comprises agitating the mixture (e.g., by applying energy to stir, pump, or move the mixture) such that it remains homogeneous prior to and during its introduction into the wellbore. The agitating can be intermittent or continuous. In some embodiments, the agitating is intermittent. In some embodiments, the agitating is continuous. In some embodiments, the agitating comprises passing the mixture through a venturi. In some embodiments, the agitating comprises pumping the mixture at a velocity disclosed herein.

In some embodiments the method further comprises agitating the mixture (e.g., by applying energy to stir, pump, or move the mixture) such that it does not visibly separate (as viewed using the naked eye) prior to its introduction into the wellbore. The agitating can be intermittent or continuous. In some embodiments, the agitating is intermittent. In some embodiments, the agitating is continuous. In some embodiments, the agitating comprises passing the mixture through a venturi. In some embodiments, the agitating comprises pumping the mixture at a velocity disclosed herein.

In some embodiments, the introducing comprises pumping the mixture into the wellbore at a velocity of at least about 50 feet per minute (about 15 meters per minute).

In embodiments, the introducing comprises pumping the mixture at a velocity of at least 20 feet/min (6 m/min), 30 feet/min (9 m/min), 40 feet/min (12 m/min), 50 feet/min (15 m/min), 60 feet/min (15 m/min), 70 feet/min (21 m/min), 80 feet/min (24 m/min), 90 feet/min (27 m/min), or 100 feet/min (30 m/min). In embodiments, the introducing comprises pumping the mixture at a velocity of 50 to 30,000 feet/min (15 m/min to 9100 m/min).

In embodiments, the introducing comprises pumping the mixture at a velocity of 20 to 1000 feet/min (6 m/min to 305 m/min). In embodiments, the introducing comprises pumping the mixture at a velocity of 50 to 1000 feet/min (15 m/min to 305 m/min). In embodiments, the introducing comprises pumping the mixture at a velocity of 50 to 500 feet/min (15 m/min to 152 m/min).

In some embodiments, the method further comprises introducing a flushing medium into the hydrocarbon bearing formation. In some embodiments, the method further comprises recovering at least a portion of the flushing medium.

Also disclosed herein is a method of decreasing or breaking down a residue that includes hydrocarbons, the method comprising contacting the residue with a mixture disclosed herein. In some embodiments, the residue includes paraffins. In some embodiments, the residue includes asphaltenes.

In some embodiments, the mixture is homogeneous (e.g., it exhibits temporary homogeneity). In some embodiments, the method further comprises agitating the mixture (e.g., by applying energy to stir, pump, or move the mixture) such that it remains homogeneous prior to the contacting. In some embodiments, the method further comprises agitating the mixture (e.g., by applying energy to stir, pump, or move the mixture) such that it remains homogeneous prior to and during the contacting. The agitating can be intermittent or continuous. In some embodiments, the agitating is intermittent. In some embodiments, the agitating is continuous. In some embodiments, the agitating comprises passing the mixture through a venturi. In some embodiments, the agitating comprises pumping the mixture at a velocity disclosed herein.

In some embodiments the method further comprises agitating the mixture (e.g., by applying energy to stir, pump, or move the mixture) such that it does not visibly separate (as viewed using the naked eye) prior to the contacting. In some embodiments the method further comprises agitating the mixture (e.g., by applying energy to stir, pump, or move the mixture) such that it does not visibly separate (as viewed using the naked eye) prior to and during the contacting. The agitating can be intermittent or continuous. In some embodiments, the agitating is intermittent. In some embodiments, the agitating is continuous. In some embodiments, the agitating comprises passing the mixture through a venturi. In some embodiments, the agitating comprises pumping the mixture at a velocity disclosed herein.

In some embodiments, the contacting comprises pumping the mixture at a velocity disclosed herein. In some embodiments, the contacting comprises pumping the mixture at a velocity of at least 50 feet per minute such that the mixture reaches the location of the residue. In some embodiments, the residue is located in a wellbore, or in a line or other equipment that is used for processing or transport of petroleum products.

Also disclosed herein is a method of treating a hydrocarbon bearing formation, the method comprising contacting the hydrocarbon bearing formation with a mixture disclosed herein. The method can include other elements or features disclosed herein. For example, in some embodiments, the method comprises agitating the mixture as disclosed herein. In some embodiments, the contacting comprises pumping the mixture into the wellbore of a well. In some embodiments, the contacting comprises pumping the mixture at a velocity disclosed herein. Also disclosed herein is a method of drawing out hydrocarbons from a hydrocarbon bearing formation, the method comprising contacting the hydrocarbon bearing formation with a mixture disclosed herein. The method can include other elements or features disclosed herein. For example, in some embodiments, the method comprises agitating the mixture as disclosed herein. In some embodiments, the contacting comprises pumping the mixture at a velocity disclosed herein. Also disclosed herein is a bulk treatment for introduction into a hydrocarbon bearing formation, the bulk treatment comprising a volume of a treatment fluid comprising chlorine dioxide, wherein the volume is such that when the treatment fluid is introduced into a wellbore of a well that penetrates the hydrocarbon bearing formation, the treatment fluid is expected to extend into the hydrocarbon bearing formation to a radial distance that goes beyond the near wellbore region. In some embodiments, the treatment fluid comprises at least 100 ppm chlorine dioxide. In some embodiments, the treatment fluid comprises at least 200 ppm chlorine dioxide. In some embodiments, the treatment fluid comprises at least 500 ppm chlorine dioxide. In some embodiments, the treatment fluid comprises at least 1000 ppm chlorine dioxide. In some embodiments, the treatment fluid comprises a mixture disclosed herein. In some embodiments, the treatment fluid is a mixture disclosed herein.

In some embodiments, the distance is at least 3 inches from the perimeter of the wellbore. In some embodiments, the distance is at least 6 inches (15 cm) from the perimeter of the wellbore. In some embodiments, the distance is at least 12 inches (30 cm), 18 inches (46 cm), 24 inches (61 cm), 36 inches (91 cm), or 48 inches (122 cm) from the perimeter of the wellbore. In some embodiments, the distance is at least 5 feet (1.5 m) from the perimeter of the wellbore.

In some embodiments, the treatment fluid is expected to extend into the formation to a radius of more than 1.5 ft (more than 0.46 m) from the center of the wellbore.

Also disclosed herein is a bulk treatment for introduction into a hydrocarbon bearing formation, the bulk treatment comprising a volume of a treatment fluid comprising at chlorine dioxide, wherein the volume is such that when the treatment fluid is introduced into a wellbore of a well that penetrates the hydrocarbon bearing formation, the treatment fluid is expected to extend into the hydrocarbon bearing formation to a radius of more than 1.5 ft (more than 0.46 m) from the center of the wellbore.

In some embodiments, the treatment fluid comprises at least 100 ppm chlorine dioxide. In some embodiments, the treatment fluid comprises at least 200 ppm chlorine dioxide. In some embodiments, the treatment fluid comprises at least 500 ppm chlorine dioxide. In some embodiments, the treatment fluid comprises at least 1000 ppm chlorine dioxide. In some embodiments, the treatment fluid comprises chlorine dioxide at a concentration of at least 2000 ppm.

In some embodiments, the volume is such that the treatment fluid is expected to extend into the formation to a radius of 1.6 feet to 10 feet (0.5 to 3 m) from the center of the wellbore.

In some embodiments, the volume is such that the treatment fluid is expected to extend into the formation to a radius of at least about 3 feet (0.9 m) from the center of the wellbore.

In some embodiments, the volume is such that the treatment fluid is expected to extend into the formation to a radius of at least about 5 feet (1.5 m) from the center of the wellbore.

In some embodiments, the volume is such that the treatment fluid is expected to extend into the formation to a radius of at least about 10 feet (3 m) from the center of the wellbore.

In some embodiments, the treatment fluid comprises chlorine dioxide at a concentration of 1000 to 50,000 ppm.

In some embodiments, the treatment fluid comprises water and/or a non-polar organic solvent.

In some embodiments, the treatment fluid comprises produced fluid.

In some embodiments, the treatment fluid comprises fluid produced from the well.

In some embodiments, the treatment fluid comprises a mixture disclosed herein. In some embodiments, the treatment fluid is a mixture disclosed herein.

In some embodiments, the treatment fluid comprises carbon dioxide (CO₂).

Also disclosed herein is a wellbore and surrounding geologic formation into which a bulk treatment disclosed herein has been introduced.

Also disclosed herein is a method of treating a hydrocarbon bearing formation, the method comprising introducing a bulk treatment disclosed herein into a wellbore of a well that penetrates the hydrocarbon bearing formation. In some embodiments, a method disclosed herein further comprises introducing carbon dioxide (CO₂) into the wellbore.

In some embodiments, the method enhances recovery of crude oil and/or natural gas from the well.

Also disclosed herein is a method of treating a hydrocarbon bearing formation, the method comprising introducing a volume of a treatment fluid comprising at least 100 ppm chlorine dioxide into a wellbore of a well, wherein the volume is such that the treatment fluid is expected to extend beyond the near wellbore region.

In some embodiments, the treatment fluid comprises at least 200 ppm chlorine dioxide. In some embodiments, the treatment fluid comprises at least 500 ppm chlorine dioxide. In some embodiments, the treatment fluid comprises at least 1000 ppm chlorine dioxide. In some embodiments, the treatment fluid comprises at least 2000 ppm chlorine dioxide.

In some embodiments, the volume is such that the treatment fluid is expected to extend a radial distance of at least 3 inches, 6 inches, 12 inches (30 cm), 18 inches (46 cm), 24 inches (61 cm), 36 inches (91 cm), or 48 inches (122 cm) from the perimeter of the wellbore.

In some embodiments, the volume is such that the treatment fluid is expected to extend more than 1.5 feet (more than 0.46 ft) from the center of the wellbore. In some embodiments, the volume is such that the treatment fluid is expected to extend 1.6 ft to 10 ft (0.5 to 3 m) from the center of the wellbore.

In some embodiments, the treatment fluid comprises carbon dioxide (CO₂).

In some embodiments, the method further comprises introducing carbon dioxide (CO₂) into the wellbore.

In some embodiments, a method disclosed herein comprises generating a treatment fluid or mixture “on the fly.” This means that at least part of the treatment fluid or mixture is generated while the treatment fluid or mixture is introduced into the wellbore.

In some embodiments, a method disclosed herein further comprises introducing a displacement fluid into the well. The displacement fluid can be used to displace the treatment fluid to a desired location in the well or surrounding formation. The displacement fluid can be, e.g., water, produced fluid, or a brine.

### BRIEF DESCRIPTION OF THE DRAWINGS

FIG. 1 shows an example of an apparatus that can be used for making a mixture disclosed herein.

FIG. 2 illustrates the cylinder method for calculating a volume of fluid (V_{F}) for introduction into a target region of a well, such that the fluid is expected to extend to a radius (r_{B}) that goes beyond the near wellbore region.

### DETAILED DESCRIPTION

### Definitions

As used herein, singular terms such as “a,” “an,” or “the” include the plural, unless the context clearly indicates otherwise.

As used herein, a “brine” or “brine fluid” is a naturally occurring or artificially created fluid comprising water and an inorganic monovalent salt, an inorganic multivalent salt, or both. An artificially created brine fluid can be prepared using one salt or a combination of two or more salts, as is known in the art. Brines can include chloride, bromide, phosphate and/or formate salts. Examples of salts that can be used in a brine fluid include potassium chloride, sodium chloride, calcium chloride, potassium bromide, sodium bromide, calcium bromide, and zinc bromide. Further examples of salts that can be used in a brine fluid include ammonium chloride, potassium phosphate, sodium formate, potassium formate, cesium formate, ethyl formate, methyl formate, methyl chloro formate, triethyl orthoformate, and trimethyl orthoformate. In some embodiments, the brine includes one or more other added components, such as a viscosifying agent (e.g., a xanthan polymer or hydroxyethylcellulose). In some embodiments, the brine is a “clear brine” that appears clear because it contains few or no suspended solids. In one embodiment, the brine is created by adding salt (e.g., a salt disclosed herein, e.g., KCl) to produced water.

As used herein, “carbon dioxide” refers to CO₂. The carbon dioxide can be gaseous carbon dioxide, supercritical carbon dioxide, or liquid carbon dioxide. In some embodiments, the carbon dioxide is carbon dioxide gas. In some embodiments, the carbon dioxide is supercritical carbon dioxide. In some embodiments, the carbon dioxide is liquid carbon dioxide.

As used herein, a “colloid” refers to a state of subdivision, implying that the molecules or polymolecular particles dispersed in a medium have at least in one direction a dimension roughly between 1 nm and 1 μm, or that in a system discontinuities are found at distances of that order. IUPAC. Compendium of Chemical Terminology, 2nd ed. (the “Gold Book”). Compiled by A. D. McNaught and A. Wilkinson. Blackwell Scientific Publications, Oxford (1997). XML on-line corrected version: http://goldbook.iupac.org (2006-) created by M. Nic, J. Jirat, B. Kosata; updates compiled by A. Jenkins. ISBN 0-9678550-9-8. doi:10.1351/goldbook. Last update: 2014-02-24; version: 2.3.3. DOI of this term: doi:10.1351/goldbook.C01172.

As used herein, a “colloidal dispersion” refers to a system in which particles of colloidal size of any nature (e.g. solid, liquid or gas) are dispersed in a continuous phase of a different composition (or state). IUPAC. Compendium of Chemical Terminology, 2nd ed. (the “Gold Book”). Compiled by A. D. McNaught and A. Wilkinson. Blackwell Scientific Publications, Oxford (1997). XML on-line corrected version: http://goldbook.iupac.org (2006-) created by M. Nic, J. Jirat, B. Kosata; updates compiled by A. Jenkins. ISBN 0-9678550-9-8. doi:10.1351/goldbook. Last update: 2014-02-24; version: 2.3.3. DOI of this term: doi:10.1351/goldbook.C01174.

As used herein, “damage” refers to an undesired residue that can arise from buildup of particles, fluids, and/or contaminants (e.g., bacteria or biomass) in a wellbore and in the immediate vicinity of the wellbore. Damage can be caused by foreign fluids or other matter introduced during petroleum industry operations. Substances that can be present in the damage include, for example, sulfides (e.g., iron sulfide), sulfur, polymers (e.g., polyacrylamides, carboxymethylcellulose, hydroxyethylcellulose, hydroxypropyl guar), xanthan gum, carbonates (e.g., calcium carbonate), hydrocarbons, paraffins, asphaltenes, bacteria, biofilm and/or biomass. In embodiments, mixtures and/or methods disclosed herein are effective to diminish damage. In preferred embodiments, the damage is skin damage. Damage can be quantified using measures known in the art, such as, e.g., skin factor and/or well flow efficiency. See, e.g., the PetroWiki article titled Formation Damage at petrowiki.org/Formation_damage, accessed Dec. 4, 2015.

As used herein and in the art, an “emulsion” refers to a fluid colloidal system in which liquid droplets and/or liquid crystals are dispersed in a liquid. The droplets often exceed the usual limits for colloids in size. IUPAC. Compendium of Chemical Terminology, 2nd ed. (the “Gold Book”). Compiled by A. D. McNaught and A. Wilkinson. Blackwell Scientific Publications, Oxford (1997). XML on-line corrected version: http://goldbook.iupac.org (2006-) created by M. Nic, J. Jirat, B. Kosata; updates compiled by A. Jenkins. ISBN 0-9678550-9-8. doi:10.1351/goldbook. Last update: 2014-02-24; version: 2.3.3. DOI of this term: doi:10.1351/goldbook.E02065.

As used herein, a “fluid” refers to a pumpable medium, which can be, e.g., a liquid, a supercritical fluid, a gas, or a mixture thereof. In some embodiments, a treatment fluid or mixture disclosed herein comprises at least 50%, 60%, 70%, 80%, 85%, 90%, 95%, 96%, 97%, 98%, or 99% liquid components. In some embodiments, a treatment fluid or mixture disclosed herein comprises at least 90% liquid components.

In some embodiments, a treatment or method disclosed herein enhances hydrocarbon recovery. A treatment or method disclosed herein is said to “enhance recovery” or to “enhance hydrocarbon recovery” when the treatment or method is followed by an increase in the production of total hydrocarbon (crude oil plus natural gas), crude oil, and/or natural gas from a well and/or when the treatment or method is followed by an increase in the hydrocarbon cut (e.g., the crude oil cut, the gas cut, or the total hydrocarbon cut of the fluid produced from a well). As exemplified herein, the “oil cut” refers to the amount of crude oil produced (which can be measured, e.g., in barrels of oil per day (BOPD)) relative to the amount of water produced (which can be measured, e.g., in barrels of water per day (BWPD)) from a well. Similarly, the “gas cut” refers to the amount of natural gas produced relative to the amount of water produced from a well. The “total hydrocarbon cut” refers to the total amount of crude oil and natural gas produced relative to the amount of water produced from a well.

In some embodiments, the increase is an increase of at least about 1, 2, 3, 4, 5, 6, 7, 8, 9, 10, 20, 25, 30, 40, 50, 60, 70, 75, 80, 90 or 100%.

In some embodiments, the increase in hydrocarbon production (e.g., crude oil and/or natural gas production) and/or the increase in hydrocarbon cut (e.g., the oil cut, the gas cut, or the total hydrocarbon cut of the well) is determined based on production values from a period of at least 1 week, 2 weeks, 1 month, 3 months, 6 months, or 12 months following the treatment. The increase can be an increase compared with the corresponding values from a baseline period just prior to the treatment (e.g., a one day, one week, two week, or one month baseline period) and/or from an original drilled production period (e.g., a one day, one week, two week, or one month period following the first production from the well).

In a preferred embodiment, enhanced recovery is indicated by an increase in the average production of hydrocarbon (e.g., crude oil and/or natural gas production) and/or by an increase in the average hydrocarbon cut (e.g., the oil cut, the gas cut, or the total hydrocarbon cut of the well) that is observed based on production values obtained for at least 30 days following treatment compared with production values obtained during a baseline period of 30 days immediately prior to the treatment. In some embodiments, the average production of hydrocarbon (e.g., crude oil and/or natural gas) and/or the average hydrocarbon cut (e.g., the oil cut, the gas cut, or the total hydrocarbon cut of the well) is increased as indicated by production values obtained for at least 1, 2, 3, 4, 5, 6, 7, 8, 9, 10, 11, or 12 months following the treatment compared with production values obtained during a baseline period and/or during an original drilled production period. The well can be a single well that is treated as disclosed herein, or the well can be group of wells in a common formation, wherein one or more of the wells in the group is treated as disclosed herein.

As used herein, a “well” is a petroleum well. The well can be a production well that is used to extract oil and/or gas, and/or the well can be an injection well.

As used herein, a “homogeneous mixture” is a mixture that has the characteristic that if any significant arbitrarily chosen volume (e.g., a macroscopic volume, such as a gallon or more) of the mixture were divided into two equal portions immediately after production of the mixture (for example, by pouring the first portion into one container and then pouring the second portion into a second container), each of the two portions would have the same essential components (those components that are specified as part of the mixture, typically including water, non-polar organic solvent, and chlorine dioxide) in the same, or approximately the same, quantities. In preferred embodiments, the amount of each of the essential components in one of the portions is within 10% of the amount of the essential components in the other portion.

As used herein, a “hydrocarbon” refers to any organic compound made up of only hydrogen and carbon (or a mixture of such organic compounds) as well as petroleum hydrocarbons such as crude oil, natural gas, bitumen and tar. Accordingly, the hydrocarbon can be one or more hydrocarbon compounds made up of only hydrogen and carbon, e.g., an aliphatic hydrocarbon (e.g., an aliphatic saturated hydrocarbon (e.g., a straight or branched chain aliphatic hydrocarbon, or a cycloalkane), an aliphatic unsaturated hydrocarbon (e.g., an alkene (olefin) or an alkyne (acetylene)), an aromatic hydrocarbon (e.g., an aromatic hydrocarbon having a single aromatic ring or two or more aromatic rings), or a mixture of such hydrocarbon compounds.

Hydrocarbon can include liquid, solid, semisolid, and/or gas components. In some embodiments, the hydrocarbon is in the form of a liquid or a gas at 20° C. and 760 mmHg. In some embodiments, the hydrocarbon is in the form of a liquid or a gas under the conditions present (e.g., when a method disclosed herein is performed). In some embodiments, the hydrocarbon is in the form of a liquid at 20° C. and 760 mmHg. In some embodiments, the hydrocarbon is in the form of a liquid (e.g., under the conditions present when a method disclosed herein is performed). In some embodiments, the hydrocarbon is a liquid or gas at 20° C. or has a melting point of 80° C. or less (at a pressure of 760 mm Hg). In some embodiments, the hydrocarbon is a liquid or gas at 20° C. or has a melting point of 50° C. or less (at a pressure of 760 mm Hg).

As used herein, a “hydrocarbon bearing formation” or “hydrocarbon bearing geologic formation” is a formation that can release hydrocarbons, e.g., crude oil and/or natural gas. Such a formation can include, e.g., source rock that generates or is capable of generating hydrocarbons and/or reservoir rock that accumulates hydrocarbons.

As used herein, the “near wellbore region” refers to the region of a hydrocarbon bearing formation that is adjacent to the wellbore and is less than about 3 inches (less than about 8 cm) from the perimeter of a wellbore.

As used herein, a “non-polar organic solvent” or “organic non-polar solvent” refers to an organic solvent (e.g., a mixture of organic solvents) that has a dielectric constant <5 and that is immiscible (insoluble) in water, or has low solubility in water, as indicated by a water solubility of less than or equal to 0.5 g/100 g. The dielectric constant and solubility in water is typically measured at an ambient temperature of 15 to 30° C. (and at a pressure of 760 mm Hg), preferably at a temperature of 20° C. Examples of organic non-polar solvents include benzene, cyclohexane, cyclopentane, diesel fuel, ethylbenzene, trimethylbenzene, hexane, heptane, kerosene, pentane, toluene, xylene, and 1,2,4,5-tetramethylbenzene. In some embodiments, the organic non-polar solvent is not soluble in water or has a water solubility of less than or equal to 0.1 g/100 g. Table 1 lists some exemplary organic non-polar solvents.

TABLE 1
Exemplary non-polar organic solvents

| | | Dielectric constant | |
|---|---|---|---|
| | Solubility in | (temperature at which | Flash point |
| Solvent | Water | measured in ° C.) | in ° C. |
| pentane | 0.04 g/100 g ⁴ | 1.84 (20)¹ | −49 ⁶ |
| hexane | 0.01 g/100 g ⁴ | 1.90 (20)¹ | −26 ⁷ |
| heptane | 0.01 g/100 g ⁴ | 1.92 (20)¹ | −4 ¹² |
| Benzene | 0.18 g/100 g ⁴ | 2.28 (20)¹ | −12 ¹³ |
| Cyclohexane | Insoluble ¹¹ | 2.02 (25)¹ | −20 ⁸ |
| Cyclopentane | Insoluble ¹¹ | 1.97 (20)¹ | −37 ¹⁴ |
| Ethylbenzene | Insoluble ¹¹ | 2.44 (20)¹ | 22 ¹⁵ |
| toluene | Insoluble ¹¹ | 2.39(20)¹ | 6 ¹⁶ |
| o-xylene | Insoluble ¹¹ | 2.56 (20)¹ | 32 ¹⁷ |
| m-xylene | Insoluble ¹¹ | 2.36 (20)¹ | 27 ¹⁸ |
| p-xylene | Insoluble ¹¹ | 2.27 (20)¹ | 27 ¹⁰ |
| 1,2,3- | Insoluble ¹¹ | 2.66(20)¹ | 11 ²⁰ |
| trimethylbenzene | | | |
| 1,2,4- | Insoluble ¹¹ | 2.38(20)¹ | 44 ¹⁹ |
| trimethylbenzene | | | |
| 1,3,5- | Insoluble ¹¹ | 2.28(20)¹ | 50 ²¹ |
| trimethylbenzene | | | |
| (mesitylene) | | | |
| Kerosene | Generally | 1.8 (21)² | 38-72° C.⁵ |
| | Insoluble | | |
| Diesel fuel | Generally | 2.1 ³ | 52 or more⁵ |
| | Insoluble | | |

¹Table 5.17 of Dean, J. A. (1999) Lange's Handbook of Chemistry, 15^{th} Edition, New York: McGraw-Hill, Inc.
² www.engineeringtoolbox.com/liquid-dielectric-constants-d_1263.html; accessed Nov. 18, 2015.
³ www.vega.com/home_tc/-/media/PDF-files/List_of_dielectric_constants_EN.ashx; accessed Nov. 18, 2015. The temperature at which this value was measured was not provided. Because the composition of diesel fuel can vary, the dielectric constant may vary; in any diesel fuel the dielectric constant is expected to be <5.
⁴ www.organicdivision.org/orig/organic_solvents.html; accessed Nov. 18, 2015.
⁵Flash point. (2015, Nov. 7). In Wikipedia, The Free Encyclopedia. Retrieved 23:04, Dec. 4, 2015, from https://en.wikipedia.org/w/index.php?title=Flash_point&oldid=689479169.
⁶ Pentane. (2015, Nov. 16). In Wikipedia, The Free Encyclopedia. Retrieved 23:58, Dec. 4, 2015, from https://en.wikipedia.org/w/index.php?title=Pentane&oldid=690958323.
⁷ Hexane. (2015, Dec. 2). In Wikipedia, The Free Encyclopedia. Retrieved 00:00, Dec. 5, 2015, from https://en.wikipedia.org/w/index.php?title=Hexane&oldid=693378563
⁸ Cyclohexane. (2015, Nov. 20). In Wikipedia, The Free Encyclopedia. Retrieved 00:01, Dec. 5, 2015, from https://en.wikipedia.org/w/index.php?title=Cyclohexane&oldid=691542839.
⁹ Ethylbenzene. (2015, Nov. 2). In Wikipedia, The Free Encyclopedia. Retrieved 22:42, Dec. 4, 2015, from https://en.wikipedia.org/w/index.php?title=Ethylbenzene&oldid=688706266
¹⁰ P-Xylene. (2015, Nov. 22). In Wikipedia, The Free Encyclopedia. Retrieved 22:46, Dec. 4, 2015, from https://en.wikipedia.org/w/index.php?title=P-Xylene&oldid=691897047
¹¹ CRC Handbook of Chemistry and Physics, 89^{th} Edition, Edited by David R. Lide, published 2008.
¹² Heptane. (2015, Nov. 22). In Wikipedia, The Free Encyclopedia. Retrieved 00:04, Dec. 5, 2015, from https://en.wikipedia.org/w/index.php?title=Heptane&oldid=691818964
¹³ Benzene. (2015, Dec. 4). In Wikipedia, The Free Encyclopedia. Retrieved 00:05, Dec. 5, 2015, from https://en.wikipedia.org/w/index.php?title=Benzene&oldid=693731378
¹⁴ Cyclopentane. (2015, Sept. 22). In Wikipedia, The Free Encyclopedia. Retrieved 00:07, Dec. 5, 2015, from https://en.wikipedia.org/w/index.php?title=Cyclopentane&oldid=682303646.
¹⁵ Ethylbenzene. (2015, Nov. 2). In Wikipedia, The Free Encyclopedia. Retrieved 00:13, Dec. 5, 2015, from https://en.wikipedia.org/w/index.php?title=Ethylbenzene&oldid=688706266.
¹⁶ Toluene. (2015, Nov. 27). In Wikipedia, The Free Encyclopedia. Retrieved 00:12, Dec. 5, 2015, from https://en.wikipedia.org/w/index.php?title=Toluene&oldid=692661894
¹⁷ O-Xylene. (2015, Nov. 16). In Wikipedia, The Free Encyclopedia. Retrieved 00:17, Dec. 5, 2015, from https://en.wikipedia.org/w/index.php?title=O-Xylene&oldid=690956607.
¹⁸ M-Xylene. (2015, Nov. 16). In Wikipedia, The Free Encyclopedia. Retrieved 00:19, Dec. 5, 2015, from https://en.wikipedia.org/w/index.php?title=M-Xylene&oldid=690955651
¹⁹ 1,2,4-Trimethylbenzene. (2015, Nov. 16). In Wikipedia, The Free Encyclopedia. Retrieved 15:34, Dec. 10, 2015, from https://en.wikipedia.org/w/index.php?title=1,2,4-Trimethylbenzene&oldid=690952112
²⁰ 1,2,3-Trimethylbenzene. (2015, Nov. 2). In Wikipedia, The Free Encyclopedia. Retrieved 15:38, Dec. 10, 2015, from https://en.wikipedia.org/w/index.php?title=1,2,3-Trimethylbenzene&oldid=688696177
²¹ Mesitylene. (2015, Jul. 14). In Wikipedia, The Free Encyclopedia. Retrieved 15:40, Dec. 10, 2015, from https://en.wikipedia.org/w/index.php?title=Mesitylene&oldid=671459559

In a preferred embodiment, chlorine dioxide shows greater solubility in the organic non-polar solvent than in water. The solubility of chlorine dioxide in water or in another solvent is typically measured at an ambient temperature of 15 to 30° C., preferably at a temperature of 20° C.

In some embodiments, the organic non-polar solvent has a flash point of at least 5° C. In some embodiments, the organic non-polar solvent has a flash point of at least 10° C. In some embodiments, the organic non-polar solvent has a flash point of at least 15° C. In some embodiments, the organic non-polar solvent has a flash point of at least 20° C. In some embodiments, the organic non-polar solvent has a flash point of at least 25° C. In some embodiments, the organic non-polar solvent has a flashpoint of at least 30° C. Flash points specified herein are determined at 760 mm Hg.

As used herein, an “organoether” refers to an organic compound that comprises an ether group. In some embodiments, the organoether is a dialkyl ether or a glycol ether. In a specific embodiment, the organoether is diisopropyl ether or a glycol ether solvent (e.g., an ethylene glycol monoalkyl ether, e.g., ethylene glycol monobutyl ether).

As used herein, a “glycol ether” can be, but is not limited to, a glycol ether solvent, an alkylene glycol dialkyl ether, and an alkylene glycol alkyl ether acetate.

As used herein, a “glycol ether solvent” can be, but is not limited to, an alkylene glycol monoalkyl ether, an alkylene glycol monoaryl ether, a dialkylene glycol monoalkyl ether, a dialkylene glycol monoaryl ether, a trialkylene glycol monoalkyl ether, or a trialkylene glycol monoaryl ether.

In typical embodiments, the alkylene glycol monoalkyl ether is an ethylene glycol monoalkyl ether or a propylene glycol monoalkyl ether. In typical embodiments, the alkylene glycol monoaryl ether is an ethylene glycol monoaryl ether or a propylene glycol monoaryl ether. In typical embodiments, the dialkylene glycol monoalkyl ether is a diethylene glycol monoalkyl ether or a dipropylene glycol monoalkyl ether. In typical embodiments, the dialkylene glycol monoaryl ether is a diethylene glycol monoaryl ether or a dipropylene glycol monoaryl ether. In typical embodiments, the trialkylene glycol monoalkyl ether is a triethylene glycol monoalkyl ether or a triproplylene glycol monoalkyl ether. In typical embodiments, the trialkylene glycol monoaryl ether is a triethylene glycol monoaryl ether or a triproplylene glycol monoaryl ether.

Accordingly, in one embodiment, the glycol ether solvent is selected from the group consisting of an ethylene glycol monoalkyl ether, a propylene glycol monoalkyl ether, an ethylene glycol monoaryl ether, a propylene glycol monoaryl ether, a diethylene glycol monoalkyl ether, a dipropylene glycol monoalkyl ether, a diethylene glycol monoaryl ether, a dipropylene glycol monoaryl ether, a triethylene glycol monoalkyl ether, a triproplylene glycol monoalkyl ether, a triethylene glycol monoaryl ether, and a triproplylene glycol monoaryl ether.

In a specific embodiment, the glycol ether solvent is selected from the group consisting of ethylene glycol monomethyl ether (2-methoxyethanol, CH₃OCH₂CH₂OH), ethylene glycol monoethyl ether (2-ethoxyethanol, CH₃CH₂OCH₂CH₂OH), ethylene glycol monopropyl ether (2-propoxyethanol, CH₃CH₂CH₂OCH₂CH₂OH), ethylene glycol monoisopropyl ether (2-isopropoxyethanol, (CH₃)₂CHOCH₂CH₂OH), ethylene glycol monobutyl ether (2-butoxyethanol, CH₃CH₂CH₂CH₂OCH₂CH₂OH), ethylene glycol monophenyl ether (2-phenoxyethanol, C₆H₅OCH₂CH₂OH), ethylene glycol monobenzyl ether (2-benzyloxyethanol, C₆H₅CH₂OCH₂CH₂OH), diethylene glycol monomethyl ether (2-(2-methoxyethoxy)ethanol, CH₃OCH₂CH₂OCH₂CH₂OH), diethylene glycol monobutyl ether (2-(2-ethoxyethoxy)ethanol, butyl carbitol, CH₃CH₂OCH₂CH₂OCH₂CH₂OH), diethylene glycol monoethyl ether (2-(2-ethoxyethoxy)ethanol, carbitol cellosolve, CH₃CH₂OCH₂CH₂OCH₂CH₂OH), and diethylene glycol mono-n-butyl ether (2-(2-butoxyethoxy)ethanol, CH₃CH₂CH₂CH₂OCH₂CH₂OCH₂CH₂OH).

A “glycol dialkyl ether” can be, but is not limited to, ethylene glycol dimethyl ether (dimethoxyethane, CH₃OCH₂CH₂OCH₃), ethylene glycol diethyl ether (diethoxyethane, CH₃CH₂OCH₂CH₂OCH₂CH₃), or ethylene glycol dibutyl ether (dibutoxyethane, CH₃CH₂CH₂CH₂OCH₂CH₂OCH₂CH₂CH₂CH₃).

An “alkylene glycol alkyl ether acetate” can be, but is not limited to, ethylene glycol methyl ether acetate (2-methoxyethyl acetate, CH₃OCH₂CH₂OCOCH₃), ethylene glycol monoethyl ether acetate (2-ethoxyethyl acetate, CH₃CH₂OCH₂CH₂OCOCH₃), ethylene glycol monobutyl ether acetate (2-butoxyethyl acetate, CH₃CH₂CH₂CH₂OCH₂CH₂OCOCH₃), and propylene glycol methyl ether acetate (1-methoxy-2-propanol acetate).

As used herein and in the art, “ppm” refers to parts per million. In the describing fluids (e.g., liquid solutions or mixtures) comprising chlorine dioxide, the present specification employs the term “ppm” to refer to parts per million by weight. As used herein, the term “ppmᵥ or ppmv” refers to parts per million by volume.

As used herein, the “percent,” “percentage” or “%” concentration of a component is intended to refer to the w/w % concentration unless the context indicates otherwise.

As used herein, the “solubility” of one substance in another is typically assessed under ambient conditions (preferably at a temperature of about 20° C. and at 760 mm Hg).

As used herein, “trimethylbenzene” can be, e.g., 1,2,3-trimethylbenzene, 1,2,4-trimethylbenzene, 1,3,5-trimethylebenzene, or any mixture of two or more of the foregoing forms.

As used herein, “water” can be, but is not limited to, fresh water, seawater, produced fluid (which includes mostly water that is produced from a petroleum well along with crude oil and/or gas), reclaimed water (e.g., treated or untreated wastewater), or a combination thereof. Accordingly, the water can include other components, such as, e.g., one or more salts, hydrocarbons, natural gas, and/or crude oil. In some embodiments, the water is a brine. Wastewater or produced fluid can be reclaimed and treated prior to use in the compositions, methods, and apparatus disclosed herein. Exemplary methods and apparatus for treatment of produced water are described, e.g., in US20140263088 and in WO2014145825. Other known methods of water treatment can also be employed. As used herein “xylene” can be, e.g., o-xylene, m-xylene, p-xylene, or any mixture of two or more of the foregoing forms of xylene. As used herein, “xylene” can also include commercially available forms of xylene that can contain up to 20% ethylbenzene in addition to m-xylene, o-xylene, and/or p-xylene. In some embodiments, the xylene is a commercially available xylene that contains 40-65% m-xylene and up to 20% each of o-xylene, p-xylene, and ethylbenzene. In some embodiments, the xylene does not include ethylbenzene.

### Enhancement of Oil and Gas Recovery

In one aspect provided herein is a bulk treatment for introduction into a hydrocarbon bearing formation, the bulk treatment comprising a volume of a treatment fluid comprising chlorine dioxide (e.g., a volume of treatment fluid having a concentration of at least 100, 200, 500, 1000, 2000, 2500, or 3000 ppm chlorine dioxide), wherein the volume is such that when the treatment fluid is introduced into a wellbore of a well that penetrates the hydrocarbon bearing formation, the treatment fluid is expected to extend into the formation to a radial distance that goes beyond the near wellbore region. In some embodiments, the distance is at least 3 inches, 6 inches (15 cm), 1 ft (30 cm), 1.5 ft (46 cm), 2 ft (61 cm), 3 ft (91 cm), or 4 ft (122 cm) from the perimeter of the wellbore. In some embodiments, the distance is at least 5 feet (1.5 m) from the perimeter of the wellbore.

In another aspect provided herein is a bulk treatment for introduction into a hydrocarbon bearing formation, the bulk treatment comprising a volume of a treatment fluid comprising chlorine dioxide, wherein the volume is such that when the treatment fluid is introduced into a wellbore of a well that penetrates the hydrocarbon bearing formation, the treatment fluid is expected to extend into the formation to a radius of more than 1.5 ft (0.46 m) from the center of the wellbore.

In embodiments, the radius is at least 1.6 feet (0.5 m) from the center of the wellbore, e.g., 1.6 to 10 feet (0.5 m to 3 m) from the center of the wellbore. In some embodiments, the radius is at least about 2 feet (0.6 m), 3 feet (0.9 m), 4 feet (1.2 m), 5 feet (1.5 m), 6 feet (1.8 m), 7 feet (2.1 m), 8 feet (2.4 m), 9 feet (2.7 m), or 10 feet (3 m) from the center of the wellbore. In some embodiments, the radius is at least about 3 feet (0.9 m) from the center of the wellbore. In some embodiments, the radius is at least about 5 feet (1.5 m) from the center of the wellbore.

A person of skill in the art can calculate a volume of treatment fluid for introduction into a hydrocarbon bearing formation (e.g., for introduction into a target region of a well, such as a producing zone of the well) such that when the treatment fluid is introduced into a wellbore of a well that penetrates a hydrocarbon bearing formation, the treatment fluid is expected to extend into the formation to a particular radius, e.g., to a radius that goes beyond the near wellbore region. Likewise, a person of skill in the art can use the information provided herein and/or methods known in the art to calculate the radius or radial distance to which a particular volume of treatment fluid is expected to extend into the formation.

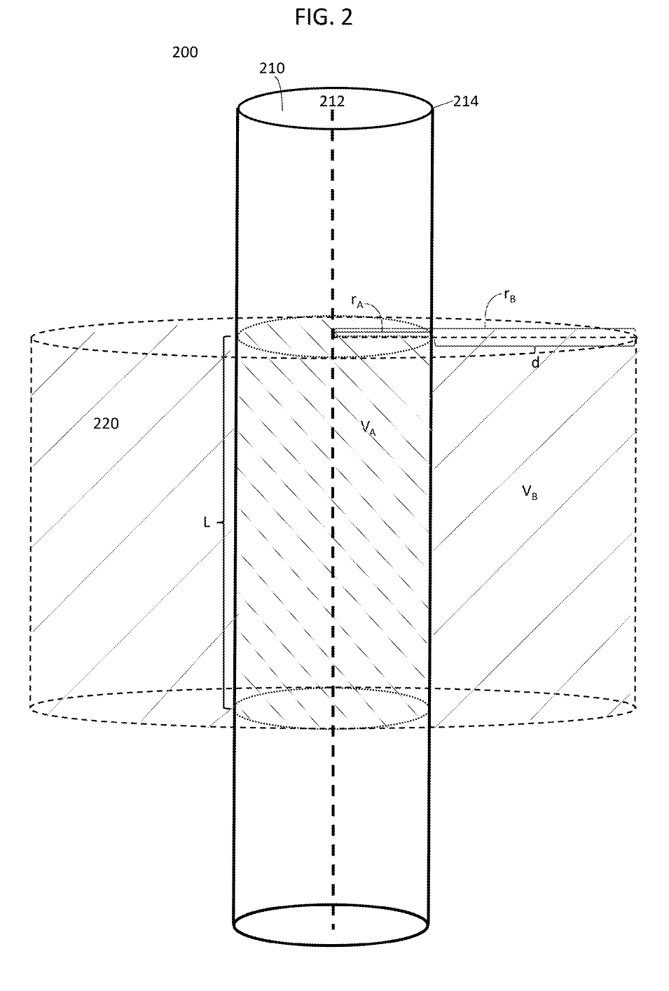

FIG. 2 provides an illustration 200 which depicts a preferred method for calculating relationships between treatment fluid volume and the radius (r_{B}) to which a volume of treatment fluid is expected to extend when the treatment fluid is introduced into a wellbore. The wellbore 210 that is depicted in FIG. 2 is vertically oriented; however, the wellbore need not be vertically oriented to apply this method of calculation.

As used herein, a “radius” or “radial distance” refers to a radius or radial distance that is measured perpendicular to the center axis of the wellbore. The radius or radial distance is measured from the “center” (i.e., from the center axis 212) of the wellbore, or, where indicated, from the perimeter (i.e., the outer edge) 214 of the wellbore, and extends outward into the formation, regardless of the orientation of the wellbore. Thus, for example, if a cylindrical wellbore were oriented horizontally, the center of the wellbore would be the center of a circular cross section taken vertically through the wellbore. The “near wellbore region” is the region of a hydrocarbon bearing formation that is adjacent to the wellbore and is less than about 3 inches from the perimeter of the wellbore. The “perimeter” refers to the perimeter of a cross section perpendicular to the longitudinal direction of the wellbore. Accordingly, for a cylindrical wellbore that has a radius of 3 inches, a radius that goes beyond the near wellbore region would be a radius of 6 inches or more as measured from the center of the wellbore, which is equivalent to a radial distance of at least 3 inches as measured from the perimeter of the wellbore.

The method depicted in FIG. 2 is referred to herein as the “cylinder method.” The target region 220 to which a treatment fluid is expected to extend (shown with lines slanting upwards from left to right) has length L. The length L can be the length of a particular target region (e.g., a producing zone) as illustrated, or it can be the entire length of the wellbore. The volume of the wellbore (V_{A}, shown with lines slanting downwards from left to right) within the target region is calculated. Generally, the wellbore itself is cylindrical or is considered to be approximately cylindrical, such that V_{A} can be calculated as follows: V_{A}=(π)(r_{A})²(L), where r_{A} is the radius of the wellbore. The volume V_{B} having a radius r_{B} (e.g., a radius r_{B} that goes beyond the near wellbore region) is calculated; typically, the volume V_{B} is also cylindrical and is calculated as V_{B}=(π)(r_{B})²(L). The volume of treatment fluid (V_{F}) that is expected to extend to radius r_{B} is calculated as V_{F}=(V_{B} V_{A})(P), where P is the porosity of the formation. The volume of treatment fluid that is expected to extend to radius r_{B} is equivalent to the volume of treatment fluid that is expected to extend a radial distance d as measured from the perimeter of the wellbore.

In the cylinder method of calculating the treatment fluid volume V_{F}, the volume of the wellbore within the region of the well to be treated (V_{A}) is subtracted, because as is known in the art, the introduction of a treatment fluid into a well generally further comprises displacing the treatment fluid, e.g., by introducing a displacement fluid into the wellbore in order to displace the treatment fluid. Methods of displacing a treatment fluid are known in the art. The displacement fluid is typically introduced after the treatment fluid. The displacement fluid typically has a volume sufficient to fill at least the volume of the wellbore within the region of the well to be treated. In some embodiments, the displacement fluid is different from the treatment fluid. In some embodiments, the displacement fluid comprises water (e.g., a brine). In some such embodiments, the displacement fluid is water (e.g., water comprising 0.1 to 7% salt, e.g., KCl). In some embodiments, the displacement fluid is a brine. In some embodiments, the displacement fluid is fluid produced from a well (e.g., from the well being treated or from another well). In some embodiments, the displacement fluid is the same as the treatment fluid. In embodiments wherein the treatment fluid is used as the displacement fluid, an additional volume of the treatment fluid is introduced after the bulk treatment to fill at least the volume of the wellbore within the region of the well to be treated (V_{A}).

The cylinder method can be applied to any type of wellbore, such as a vertically drilled wellbore or a wellbore that has been subjected to hydraulic fracturing. For wells that have undergone hydraulic fracturing (“fracking” or “fracking”), an alternative to the cylinder method, referred to herein as the “sand method” can also be used to calculate a volume of treatment fluid (V_{F}*) for introduction into a well (e.g., for introduction into a target region of a well, such as a producing zone of the well) such that that when the treatment fluid is introduced into the well (e.g., into a target region of a well, e.g., a producing zone), the treatment fluid is expected to extend to a radius that goes beyond the near wellbore region. Although the sand method, in contrast to the cylinder method, is not calculated based on the particular radius to which the fluid is expected to extend, the volume calculated using the sand method is typically larger than the volume obtained if one were to use the cylinder method to calculate the volume needed to extend into the formation to a radius that goes beyond the near wellbore region.

According to the sand method, V_{F*}=V_{S}(P_{S}), where V_{S} is the volume of propping agent (e.g., frac sand) left in place following fracking and P_{S} is the porosity of the propping agent (e.g., the frac sand) that was employed. To provide a hypothetical example, if 100,000 barrels of fracking fluid comprising 12% frac sand were introduced into a well (i.e., 12,000 barrels of frac sand is introduced) and one quarter of that fluid were retrieved (i.e., 3,000 barrels of frac sand is retrieved), then 9,000 barrels of frac sand would have been left in place following the fracking operation. If the porosity of the sand were 33.3%, then V_{F*} would be 3,000 barrels. As with the cylinder method, if only a target region around a wellbore, as opposed to the entire region around the wellbore, is to be treated, the volume V_{F*} can be reduced to reflect the estimated proportion of the propping agent (e.g., frac sand) that went into the area to be treated. Furthermore, as noted with regard to the cylinder method, the sand method typically does not include the volume of the wellbore within the region of the well to be treated because introducing the treatment fluid typically further comprises introducing a displacement fluid into the wellbore after the treatment fluid in order to displace the treatment fluid. If no fluid other than the treatment fluid is used to displace the treatment fluid, then the volume V_{F*} would be increased by the estimated volume of the wellbore within the region of the well to be treated.

Methods known in the art can be used to selectively treat particular areas of a well. For example, packers can be used to prevent displacement of treatment fluid into areas outside of the desired treatment region. In some embodiments, a PinPoint Injection (PPI) packer is used to introduce the treatment fluid into the well.

In some embodiments, the treatment fluid comprises chlorine dioxide at a concentration of at least 100 ppm. In some embodiments, the treatment fluid comprises chlorine dioxide at a concentration of at least 200 ppm. In some embodiments, the treatment fluid comprises chlorine dioxide at a concentration of at least 500 ppm. In some embodiments, the treatment fluid comprises chlorine dioxide at a concentration of at least 500 ppm.

In some embodiments, the treatment fluid comprises chlorine dioxide at a concentration of up to 10,000 ppm. In some embodiments, the treatment fluid comprises chlorine dioxide at a concentration of up to 20,000 ppm. In some embodiments, the treatment fluid comprises chlorine dioxide at a concentration of up to 30,000 ppm. In some embodiments, the treatment fluid comprises chlorine dioxide at a concentration of up to 40,000 ppm. In some embodiments, the treatment fluid comprises chlorine dioxide at a concentration of up to 50,000 ppm.

In some embodiments, the treatment fluid comprises chlorine dioxide at a concentration of 100 to 50,000 ppm. In some embodiments, the treatment fluid comprises chlorine dioxide at a concentration of 500 to 50,000 ppm. In some embodiments, the treatment fluid comprises chlorine dioxide at a concentration of at least 500 ppm. In some embodiments, the treatment fluid comprises chlorine dioxide at a concentration of at least 1000 ppm. In some embodiments, the treatment fluid comprises chlorine dioxide at a concentration of 1000 to 50,000 ppm. In some embodiments, the treatment fluid comprises chlorine dioxide at a concentration of 200 to 20,000 ppm. In some embodiments, the treatment fluid comprises chlorine dioxide at a concentration of 1000 to 20,000 ppm. In some embodiments, the treatment fluid comprises chlorine dioxide at a concentration of 1000 to 6000 ppm. In some embodiments, the treatment fluid comprises chlorine dioxide at a concentration of 2500 to 3500 ppm, e.g., at a concentration of about 3000 ppm.

Because the bulk treatment comprises a significant volume of fluid, the concentration of chlorine dioxide within smaller samples of the volume may vary. Accordingly, the concentration of chlorine dioxide in the treatment fluid refers to the average concentration, which can be assessed based on the average concentration in a group of representative samples (e.g., at least 5, 10, 25, or 50 representative samples) from the volume of treatment fluid.

In typical embodiments, the treatment fluid is a mixture of liquid and gas. In some embodiments, the treatment fluid comprises at least 50%, 60%, 70%, 80%, 85%, 90%, or 95% liquid components. In some embodiments, the treatment fluid comprises at least 90% liquid components.

In some embodiments, the treatment fluid is a gas. In a specific embodiment, the gas comprises carbon dioxide (e.g., chlorine dioxide at a concentration of 1000 to 50,000 ppmᵥ or 1000 to 20,000 ppmᵥ). In a specific embodiment, the gas consists essentially of carbon dioxide and chlorine dioxide (e.g., chlorine dioxide at a concentration of 1000 to 50,000 ppmᵥ).

In some embodiments, the treatment fluid comprises water. In some embodiments, the treatment fluid consists essentially of water and chlorine dioxide. In some embodiments, the treatment fluid consists of water and chlorine dioxide.

In some embodiments, the treatment fluid comprises fluid produced from the well. In some embodiments, the treatment fluid consists essentially of fluid produced from the well and chlorine dioxide. In some embodiments, the treatment fluid consists of fluid produced from the well and chlorine dioxide.

In some embodiments, the treatment fluid comprises a non-polar organic solvent, e.g., a non-polar organic solvent disclosed herein. In some embodiments, the treatment fluid consists essentially of the non-polar organic solvent and chlorine dioxide. In some embodiments, the treatment fluid consists of the non-polar organic solvent and chlorine dioxide.

In some embodiments, the treatment fluid comprises water and/or a non-polar organic solvent, e.g., a non-polar organic solvent disclosed herein. In some embodiments, the treatment fluid comprises a mixture disclosed herein (e.g., a mixture comprising water, chlorine dioxide, a non-polar organic solvent, and optionally, an acid or chelating agent and/or a surfactant or cosolvent). In some embodiments, the treatment fluid consists essentially of a mixture disclosed herein. In some embodiments, the treatment fluid is a mixture disclosed herein.

In some embodiments, the treatment fluid further comprises carbon dioxide (CO₂).

In another aspect provided herein is a wellbore and surrounding geologic formation (e.g., a hydrocarbon-bearing formation) into which a bulk treatment disclosed herein has been introduced.

In another aspect provided herein is a method of treating a well, the method comprising introducing a bulk treatment disclosed herein into a wellbore of the well.

In another aspect provided herein is a method of treating a hydrocarbon-bearing formation, the method comprising introducing a bulk treatment disclosed herein into a wellbore of a well that penetrates the hydrocarbon-bearing formation.

In another aspect provided herein is a method of treating a hydrocarbon-bearing formation, the method comprising introducing a bulk treatment into the wellbore of a well that penetrates the hydrocarbon-bearing formation, wherein said bulk treatment comprises a volume of a treatment fluid comprising chlorine dioxide, wherein the volume is such that when the treatment fluid is introduced into the well, the treatment fluid is expected to extend to a radius that goes beyond the near wellbore region. In preferred embodiments, the radius that goes beyond the near wellbore region is more than 1.5 ft (0.46 m) from the center of the wellbore. In other embodiments, the volume is such that the treatment fluid is expected to extend to a radius or radial distance disclosed herein.

In another aspect provided herein is method of treating a hydrocarbon-bearing formation, the method comprising introducing a bulk treatment into the wellbore of a well that penetrates the hydrocarbon-bearing formation, wherein said bulk treatment comprises a volume of a treatment fluid comprising chlorine dioxide, wherein the volume is such that when the treatment fluid is introduced into a wellbore of a well that penetrates the hydrocarbon bearing formation, the treatment fluid is expected to extend into the formation to a radius more than 1.5 ft (0.46 m) from the center of the wellbore.

In embodiments, the radius is at least 1.6 feet (0.5 m) from the center of the wellbore, e.g., 1.6 to 10 feet (0.5 m to 3 m) from the center of the wellbore. In some embodiments, the radius is at least about 2 feet (0.6 m), 3 feet (0.9 m), 4 feet (1.2 m), 5 feet (1.5 m), 6 feet (1.8 m), 7 feet (2.1 m), 8 feet (2.4 m), 9 feet (2.7 m), or 10 feet (3 m) from the center of the wellbore. In some embodiments, the radius is at least about 3 feet (0.9 m) from the center of the wellbore. In some embodiments, the radius is at least about 5 feet (1.5 m) from the center of the wellbore.

In some embodiments of the methods, the introducing comprises displacing the bulk treatment with a displacement fluid that differs from the treatment fluid. In some embodiments, the displacement fluid comprises water (e.g., water comprising 0.1 to 10% or 0.1 to 7% of a salt (e.g., KCl)). In some embodiments, the displacement fluid is water (e.g., water comprising 0.1 to 10% or 0.1 to 7% of a salt (e.g., KCl)). In some embodiments, the displacement fluid comprises produced fluid. In some embodiments, the displacement fluid is produced fluid.

In some embodiments of the methods, the introducing comprises introducing the entire volume of a treatment fluid without introducing any other treatment during the introducing. The introducing can be continuous or in increments. In some embodiments, the volume is introduced continuously (e.g., by continuous pumping into a wellbore). In some embodiments, the volume is introduced in increments (e.g., by non-continuous pumping into a wellbore). In some embodiments, another treatment or fluid is introduced before or after introducing the entire volume. In yet other embodiments, another treatment or fluid is introduced before, concurrently and intermittently with, non-concurrently and intermittently with, or after introducing the entire volume.

In other embodiments, the introducing comprises introducing the bulk treatment in two or more increments. In some embodiments, one or more other treatments or fluids is introduced between increments. In some embodiments, one or more other treatments or fluids is introduced before, during, or after the introduction of any one or more of the increments.

In some embodiments, the methods further comprise introducing carbon dioxide (CO₂) into the wellbore. In some embodiments, the carbon dioxide is supercritical carbon dioxide. In some embodiments, the carbon dioxide is gaseous carbon dioxide.

In some embodiments, the methods enhance recovery of crude oil and/or gas from one or more wells within the hydrocarbon-bearing formation. In some embodiments, the methods enhance recovery of hydrocarbon (e.g., crude oil and/or natural gas) from the well into which the bulk treatment is introduced.

### Mixtures Including Chlorine Dioxide, Water, and Organic Solvent(s)

Applicant has developed fluid mixtures that include water, one or more non-polar organic solvents, and chlorine dioxide; methods of making and using the mixtures; and apparatus for making the mixtures. Such mixtures can be used advantageously in the petroleum industry, e.g., as a treatment to diminish damage in a well, to improve permeability of a hydrocarbon-producing formation, to mitigate declining crude oil or gas production (e.g., to reduce the decline in production or reduce the rate of decline in production), and/or to enhance hydrocarbon recovery.

In one aspect, the present disclosure provides a mixture comprising chlorine dioxide, water, an organic non-polar solvent, and optionally one or more additional components. In many embodiments, the mixtures further comprise an acid or chelating agent and/or a surfactant or cosolvent. Also provided herein are methods of making and using the mixtures, and apparatus for producing the mixtures.

In embodiments, a mixture or method disclosed herein enhances hydrocarbon recovery.

In embodiments, a mixture or method disclosed herein enhances crude oil production. In embodiments, a mixture or method disclosed herein enhances natural gas production. In embodiments, a mixture or method disclosed herein enhances crude oil and natural gas production.

In embodiments, a mixture or method disclosed herein enhances oil cut. In embodiments, a mixture or method disclosed herein enhances gas cut. In embodiments, a mixture or method disclosed herein enhances total hydrocarbon cut.

In aspects and embodiments, the present disclosure pertains to mixtures comprising chlorine dioxide, water, and organic non-polar solvent. Water and the organic non-polar solvent are incompatible materials, in the sense that they typically are immiscible and/or have low solubility in each other. Accordingly, in preferred embodiments, the mixtures described herein require energy input (such as, e.g., mixing, shaking or stirring, e.g., via venturi mixing or the like) to be combined into a mixture, e.g., a homogenous mixture.

In one aspect provided herein is a mixture comprising (a) water, (b) chlorine dioxide, and (c) an organic non-polar solvent.

In some embodiments, the mixture is homogeneous and/or produced using a venturi.

In some embodiments, the mixture comprises chlorine dioxide at a concentration of at least 100 ppm. In some embodiments, the mixture comprises chlorine dioxide at a concentration of at least 200 ppm. In some embodiments, the mixture comprises chlorine dioxide at a concentration of at least 500 ppm. In some embodiments, the mixture comprises chlorine dioxide at a concentration of at least 1000 ppm. In some embodiments, the mixture comprises chlorine dioxide at a concentration of at least 2000 ppm.

In some embodiments, the mixture comprises chlorine dioxide at a concentration of up to 10,000 ppm. In some embodiments, the mixture comprises chlorine dioxide at a concentration of up to 20,000 ppm. In some embodiments, the mixture comprises chlorine dioxide at a concentration of up to 30,000 ppm. In some embodiments, the mixture comprises chlorine dioxide at a concentration of up to 40,000 ppm. In some embodiments, the mixture comprises chlorine dioxide at a concentration of up to 50,000 ppm.

In some embodiments, the mixture comprises chlorine dioxide at a concentration of 100 to 50,000 ppm. In some embodiments, the mixture comprises chlorine dioxide at a concentration of 500 to 50,000 ppm. In some embodiments, the mixture comprises chlorine dioxide at a concentration of at least 500 ppm. In some embodiments, the mixture comprises chlorine dioxide at a concentration of at least 1000 ppm. In some embodiments, the mixture comprises chlorine dioxide at a concentration of 1000 to 50,000 ppm. In some embodiments, the mixture comprises chlorine dioxide at a concentration of 200 to 20,000 ppm. In some embodiments, the mixture comprises chlorine dioxide at a concentration of 1000 to 20,000 ppm. In some embodiments, the mixture comprises chlorine dioxide at a concentration of 1000 to 6000 ppm. In some embodiments, the mixture comprises chlorine dioxide at a concentration of 2500 to 3500 ppm, e.g., at a concentration of about 3000 ppm.

In a particular embodiment, the chlorine dioxide is at a concentration of at least 1000 ppm (e.g., 1000 to 50,000 ppm, e.g., 1000 to 20,000 ppm).

In some embodiments, the mixture contains the organic non-polar solvent at a concentration of at least 0.1%, 0.5%, 1%, 2%, 2.5%, 3%, 4%, or 5%.

In some embodiments, the mixture contains the organic non-polar solvent at a concentration of up to 30%, 40%, 50%, 60%, 70%, or 80%.

In some embodiments, the mixture contains the organic non-polar solvent at a concentration of 0.1% to 90%, e.g., 1% to 90% or 2% to 90%.

In some embodiments, the mixture contains the organic non-polar solvent at a concentration of up to 20% (e.g., at a concentration of 0.1% to 20%, 0.5% to 20%, 1% to 20%, 2 to 20%, 3 to 20%, 4 to 20% or 5 to 20%). In some embodiments, the mixture contains the organic non-polar solvent at a concentration of 0.5-10% (e.g., 1 to 10%, e.g., 1-7%, 2-7%, 3-7% or 4-7%). In some embodiments, the mixture contains the organic non-polar solvent at a concentration of 2.5 to 5%.

In some embodiments, the organic non-polar solvent is at a concentration of 0.1 to 20%, 0.1 to 10%, 0.1 to 7%, or 0.1 to 5%, or 0.1 to 2%. In some embodiments, the organic non-polar solvent is at a concentration of 0.5 to 20%, 0.5 to 10%, 0.5 to 7%, 0.5 to 5%, or 0.5 to 2%. In some embodiments, the organic non-polar solvent is at a concentration of 1 to 20%, 1 to 10%, 1 to 7%, 1 to 5%, or 1 to 2%.

In some embodiments, the organic non-polar solvent comprises benzene, cyclohexane, cyclopentane, diesel fuel (e.g., petroleum diesel), ethylbenzene, trimethylbenzene, hexane, heptane, kerosene, pentane, toluene, or xylene. In some embodiments, the organic non-polar solvent is selected from the group consisting of benzene, cyclohexane, cyclopentane, diesel fuel (e.g., petroleum diesel), ethylbenzene, trimethylbenzene, hexane, heptane, kerosene, pentane, toluene, and xylene. In some embodiments, the solvent is a combination of two or more of the foregoing solvents.

In some embodiments, the organic non-polar solvent comprises ethylbenzene, toluene, o-xylene, m-xylene, p-xylene, kerosene, or diesel fuel. In some embodiments, the organic non-polar solvent is selected from the group consisting of ethylbenzene, toluene, o-xylene, m-xylene, p-xylene, kerosene, and diesel fuel. In some embodiments, the solvent is a combination of two or more of the foregoing solvents.

Typically, the solubility of chlorine dioxide in the organic non-polar solvent is at least as high as the solubility of chlorine dioxide in water. In some embodiments, the solubility of chlorine dioxide in the organic non-polar solvent is higher than the solubility of chlorine dioxide in water.

In some embodiments, the mixture is produced using a venturi. In embodiments, some or all of the components of the mixture are mixed using a venturi. In some embodiments, at least the water, the chlorine dioxide, and the non-polar organic solvent are venturi mixed. In embodiments, the mixture is venturi mixed. In embodiments, the mixture is produced using venturi mixing. In embodiments, the mixture is produced using methods disclosed herein.

In some embodiments, the mixture is not clear or translucent. In some embodiments, the mixture is not able to be seen through using the naked eye.

In some embodiments, the mixture is a homogenous mixture. In some embodiments, the mixture does not separate when allowed to stand for at least 5, 10, 15, 20, 30, 40, 45, 50, or 60 minutes. A mixture shall be considered not to have separated if there is no visible separation, as viewed using the naked eye.

In some embodiments, the mixture stays homogenous for at least 5, 10, 15, 20, 30, 40, 45, 50, or 60 minutes after production.

In some embodiments, a mixture disclosed herein is agitated (e.g., by applying energy to stir, pump, or move the mixture) such that it stays homogeneous until it can be used. The agitation can be intermittent or continuous. In some embodiments, the agitation is intermittent. In some embodiments, the agitation is continuous. In some embodiments, the agitation comprises passing the mixture through a venturi.

In some embodiments, a mixture disclosed herein is agitated (e.g., by applying energy to stir, pump, or move the mixture) such that it does not visibly separate (as viewed using the naked eye) until it can be used. The agitation can be intermittent or continuous. In some embodiments, the agitation is intermittent. In some embodiments, the agitation is continuous. In some embodiments, the agitation comprises passing the mixture through a venturi.

In some embodiments, the mixture exhibits temporary homogeneity. In some such embodiments, the mixture separates over time if the mixture is allowed to stand. In some embodiments, the mixture separates if the mixture is allowed to stand for at least 30, 45, or 60 minutes. In some embodiments, the mixture separates if the mixture is allowed to stand for at least 1.5, 2, 3, 4, or 6 hours.

In some embodiments, the mixture does not show significant separation when pumped at a velocity of at least 20 feet/min (6 m/min), 30 feet/min (9 m/min), 40 feet/min (12 m/min), 50 feet/min (15 m/min), 60 feet/min (15 m/min), 70 feet/min (21 m/min), 80 feet/min (24 m/min), 90 feet/min (27 m/min), or 100 feet/min (30 m/min). In embodiments, the mixture does not show significant separation when pumped at a velocity of 50 to 30,000 feet/min (15 m/min to 9100 m/min). A mixture shall be considered not to show significant separation if there is no visible separation of the mixture, as viewed using the naked eye.

In some embodiments, the mixture does not show significant separation when pumped at a velocity of 20 to 1000 feet/min (6 m/min to 305 m/min). In embodiments, the mixture does not show significant separation when pumped at a velocity of 50 to 1000 feet/min (15 m/min to 305 m/min). In embodiments, the mixture does not show significant separation when pumped at a velocity of 50 to 500 feet/min (15 m/min to 152 m/min).

In some embodiments, the mixture is a colloidal dispersion. In some such embodiments, the mixture separates over time if the mixture is allowed to stand, e.g., for a period of time disclosed herein.

In some embodiments, the mixture is an emulsion. In some embodiments, the emulsion is not stable. In some such embodiments, the emulsion separates over time if the mixture is allowed to stand, e.g., for a period of time disclosed herein.

In some embodiments, the mixture is not a microemulsion. In some embodiments, the mixture is not a stable microemulsion.

In some embodiments, the mixture is an azeotrope. In some embodiments, the azeotrope separates over time if the mixture is allowed to stand, e.g., for a period of time disclosed herein.

In embodiments, the mixture diminishes damage in a well when it is introduced into the well, e.g., when it is pumped into the well (e.g., into the wellbore of the well) at a velocity of at least 20 feet/min (6 m/min), 30 feet/min (9 m/min), 40 feet/min (12 m/min), 50 feet/min (15 m/min), 60 feet/min (15 m/min), 70 feet/min (21 m/min), 80 feet/min (24 m/min), 90 feet/min (27 m/min), or 100 feet/min (30 m/min), or when it is pumped into the well (e.g., into the wellbore of the well) at a velocity of 50 to 30,000 feet/min (15 m/min to 9100 m/min).

In embodiments, the mixture enhances hydrocarbon recovery from a well when it is introduced into the well, e.g., when it is pumped into the well (e.g., into the wellbore of the well) at a velocity of at least 20 feet/min (6 m/min), 30 feet/min (9 m/min), 40 feet/min (12 m/min), 50 feet/min (15 m/min), 60 feet/min (15 m/min), 70 feet/min (21 m/min), 80 feet/min (24 m/min), 90 feet/min (27 m/min), or 100 feet/min (30 m/min), or when it is pumped into the well (e.g., into the wellbore of the well) at a velocity of 50 to 30,000 feet/min (15 m/min to 9100 m/min).

In embodiments, the mixture comprises chlorine dioxide at a concentration of 500 to 50,000 ppm. In embodiments, the chlorine dioxide is present in the mixture at a concentration of 1000 to 20,000 ppm. In embodiments, the chlorine dioxide is at a concentration of 1000 to 6000 ppm. In embodiments, the chlorine dioxide is at a concentration of 2500-3500 ppm, e.g., at a concentration of about 3000 ppm.

In embodiments, the mixture comprises a salt. In some embodiments, the mixture comprises the salt at a concentration of up to 15, 20 or 25%. In some embodiments, the mixture comprises the salt at a concentration of up to 10%, e.g., at a concentration of up to 7%, 5%, or 2%. In some embodiments, the mixture comprises the salt at a concentration of at least 0.01%, 0.1%, 0.5% or 1%. In some embodiments, the mixture comprises the salt at a concentration of 0.01 to 20%, 0.1 to 20%, 0.5 to 20%, 1 to 20%, 0.01 to 10%, 0.1 to 10%, 0.5 to 10%, 1 to 10%, 0.01 to 7%, 0.1 to 7%, 0.5 to 7%, 1 to 7%, 0.01 to 5%, 0.1 to 5%, 0.5 to 5%, 1 to 5%, 0.01 to 2%, 0.1 to 2%, 0.5 to 2%, or 1 to 2%.

In some embodiments, the salt comprises potassium chloride, sodium chloride, calcium chloride, potassium bromide, sodium bromide, calcium bromide, zinc bromide, ammonium chloride, potassium phosphate, sodium formate, potassium formate, cesium formate, ethyl formate, methyl formate, methyl chloro formate, triethyl orthoformate, or trimethyl orthoformate. In embodiments, the salt is selected from the group consisting of potassium chloride, sodium chloride, calcium chloride, potassium bromide, sodium bromide, calcium bromide, zinc bromide, ammonium chloride, potassium phosphate, sodium formate, potassium formate, cesium formate, ethyl formate, methyl formate, methyl chloro formate, triethyl orthoformate, and trimethyl orthoformate. In some embodiments, the salt is a mixture of two or more of the foregoing salts.

In some embodiments, the salt comprises potassium chloride, sodium chloride, calcium chloride, potassium bromide, sodium bromide, calcium bromide, or zinc bromide. In embodiments, the salt is selected from the group consisting of potassium chloride, sodium chloride, calcium chloride, potassium bromide, sodium bromide, calcium bromide, and zinc bromide. In some embodiments, the salt is a mixture of two or more of the foregoing salts.

In embodiments, the water comprises a salt. In embodiments, the water comprising a salt is a brine. In embodiments, the salt comprises potassium chloride, sodium chloride, calcium chloride, potassium bromide, sodium bromide, calcium bromide, zinc bromide, ammonium chloride, potassium phosphate, sodium formate, potassium formate, cesium formate, ethyl formate, methyl formate, methyl chloro formate, triethyl orthoformate, or trimethyl orthoformate. In embodiments, the salt is selected from the group consisting of potassium chloride, sodium chloride, calcium chloride, potassium bromide, sodium bromide, calcium bromide, zinc bromide, ammonium chloride, potassium phosphate, sodium formate, potassium formate, cesium formate, ethyl formate, methyl formate, methyl chloro formate, triethyl orthoformate, and trimethyl orthoformate.

In embodiments, the salt comprises potassium chloride, sodium chloride, calcium chloride, potassium bromide, sodium bromide, calcium bromide, and zinc bromide. In embodiments, the salt is selected from the group consisting of potassium chloride, sodium chloride, calcium chloride, potassium bromide, sodium bromide, calcium bromide, and zinc bromide.

In some embodiments, the water comprises a salt at a concentration disclosed herein; such concentration refers to the total concentration of salt in the water at the time that the water is used to make the mixture.

In some embodiments, the water comprises salt at a concentration of up to 30%, 25%, 20% or 15%.

In some embodiments, the water comprises salt at a concentration of 0.1 to 25%, 1 to 25%, or 2 to 25%. In some embodiments, the water comprises salt at a concentration of 0.1 to 20%, 1 to 20%, or 2 to 20%.

In some embodiments, the water comprises salt at a concentration of up to 10%, e.g., at a concentration of up to 7%, 5%, or 2%. In some embodiments, the water comprises salt at a concentration of at least 0.01%, 0.1%, 0.5% or 1%.

In some embodiments, the water comprises salt at a concentration of 0.1 to 10%; 0.1 to 7%; 1 to 7%; or 1 to 5%.

In one embodiment, the salt is potassium chloride.

In one embodiment, the water comprises potassium chloride at a concentration of about 2%.

In some embodiments, the mixture further comprises an acid or a chelating agent. In one embodiment, the mixture contains the acid or chelating agent is at a concentration of up to 20% (e.g., at a concentration of 0.1 to 20%). In some embodiments, the mixture contains the acid or chelating agent at a concentration of 1 to 20%, 0.1 to 10%, 1 to 10%, 1 to 8%, or 2 to 5%.

In embodiments, the acid or chelating agent comprises acetic acid, adenosine monophosphate (AMP), carbonic acid, citric acid, ethylenediaminetetraacetic acid (EDTA), glycolic acid (hydroxyacetic acid), gluconic acid, 1-hydroxyethane 1,1-diphosphonic acid (HEDP), hydrochloric acid, hydrofluoric acid, nitric acid, nitrilotriacetic acid (NTA), 2-phosphonobutane-1,2,4-tricarboxylic acid, phosphoric acid, a polyphosphate, sulfuric acid, and tartaric acid. In embodiments, the acid or chelating agent is selected from the group consisting of acetic acid, adenosine monophosphate (AMP), carbonic acid, citric acid, ethylenediaminetetraacetic acid (EDTA), glycolic acid (hydroxyacetic acid), gluconic acid, 1-hydroxyethane 1,1-diphosphonic acid (HEDP), hydrochloric acid, hydrofluoric acid, nitric acid, nitrilotriacetic acid (NTA), 2-phosphonobutane-1,2,4-tricarboxylic acid, phosphoric acid, a polyphosphate, sulfuric acid, and tartaric acid. In some such embodiments, the acid or chelating agent is a mixture of two or more of the foregoing. In certain embodiments, the acid is a chelating acid.

In embodiments, the acid or chelating agent is selected from the group consisting of acetic acid, citric acid, carbonic acid, oxalic acid, hydrochloric acid, and hydrofluoric acid. In some such embodiments, the acid or chelating agent is a mixture of two or more of the foregoing.

In embodiments, the acid or chelating agent comprises citric acid, acetic acid, or EDTA. In embodiments, the acid or chelating agent is selected from the group consisting of citric acid, acetic acid, or EDTA. In some such embodiments, the acid or chelating agent is a mixture of two or more of the foregoing.

In embodiments, the acid or chelating agent comprises citric acid. In embodiments, the acid is citric acid. In embodiments, the acid comprises acetic acid. In embodiments, the acid is acetic acid. In embodiments, the acid is selected from citric acid and acetic acid. In embodiments, the acid is citric acid.

In some embodiments, the mixture further comprises up to 5% of a surfactant or cosolvent. In some embodiments, the mixture comprises up to 4%, 3%, 2%, or 1% of the surfactant or cosolvent.

In embodiments, the mixture comprises 0.1 to 5% of the surfactant or cosolvent. In embodiments, the mixture comprises 0.1 to 4%, 0.1 to 3%, 0.1 to 2%, or 0.1 to 1% of the surfactant or cosolvent. In embodiments, the mixture comprises 0.5 to 5%, 0.5 to 4%, 0.5 to 3%, 0.5 to 2% or 0.5 to 1% of the surfactant or cosolvent. In embodiments, the mixture comprises 1 to 5% of the surfactant or cosolvent.

In embodiments, the surfactant or cosolvent is an organoether. In some embodiments, the organoether is a dialkyl ether or a glycol ether. In a specific embodiment, the organoether is diisopropyl ether or a glycol ether solvent (e.g., an ethylene glycol monoalkyl ether, e.g., ethylene glycol monobutyl ether). In one embodiment, the glycol ether is a glycol ether solvent, an alkylene glycol dialkyl ether, and an alkylene glycol alkyl ether acetate. In one embodiment, the surfactant or cosolvent is a glycol ether solvent. In a specific embodiment, the glycol ether solvent is selected from the group consisting of ethylene glycol monomethyl ether (2-methoxyethanol, CH₃OCH₂CH₂OH), ethylene glycol monoethyl ether (2-ethoxyethanol, CH₃CH₂OCH₂CH₂OH), ethylene glycol monopropyl ether (2-propoxyethanol, CH₃CH₂CH₂OCH₂CH₂OH), ethylene glycol monoisopropyl ether (2-isopropoxyethanol, (CH₃)₂CHOCH₂CH₂OH), ethylene glycol monobutyl ether (2-butoxyethanol, CH₃CH₂CH₂CH₂OCH₂CH₂OH), ethylene glycol monophenyl ether (2-phenoxyethanol, C₆H₅OCH₂CH₂OH), ethylene glycol monobenzyl ether (2-benzyloxyethanol, C₆H₅CH₂OCH₂CH₂OH), diethylene glycol monomethyl ether (2-(2-methoxyethoxy)ethanol, CH₃OCH₂CH₂OCH₂CH₂OH), diethylene glycol monobutyl ether (2-(2-ethoxyethoxy)ethanol, butyl carbitol, CH₃CH₂OCH₂CH₂OCH₂CH₂OH), diethylene glycol monoethyl ether (2-(2-ethoxyethoxy)ethanol, carbitol cellosolve, CH₃CH₂OCH₂CH₂OCH₂CH₂OH), and diethylene glycol mono-n-butyl ether (2-(2-butoxyethoxy)ethanol, CH₃CH₂CH₂CH₂OCH₂CH₂OCH₂CH₂OH).

In a certain embodiment, the surfactant or cosolvent is ethylene glycol monobutyl ether (EGMBE), e.g., at a concentration of up to 5%. In some embodiments, the mixture comprises up to 4%, 3%, 2%, or 1% of the EGMBE. In embodiments, the mixture comprises 0.1 to 5% of the EGMBE. In embodiments, the mixture comprises 0.1 to 4%, 0.1 to 3%, 0.1 to 2%, or 0.1 to 1% of the EGMBE. In embodiments, the mixture comprises 0.5 to 5%, 0.5 to 4%, 0.5 to 3%, 0.5 to 2% or 0.5 to 1% of the EGMBE. In embodiments, the mixture comprises 1 to 5% of the EGMBE. In one embodiment, the mixture does not comprise any other surfactant.

In some embodiments, the mixture does not comprise a surfactant.

In some embodiments, the mixture is
(a) a water based mixture comprising
   i) water (e.g., water comprising 0.1-10%, 0.1 to 7%, or 1 to 7%, or about 2% of a salt, e.g., a salt disclosed herein, e.g., KCl),
   ii) chlorine dioxide at a concentration of at least 500 ppm or 1000 ppm (e.g., at a concentration of 500 to 20,000 ppm or 1000 to 20,000 ppm, e.g., at a concentration of 1000 to 6000 ppm, e.g., at a concentration of 2500 to 3500 ppm, e.g., at a concentration of about 3000 ppm), and
   iii) a non-polar organic solvent at a concentration of up to 20% (e.g., at a concentration specified elsewhere herein);
   and optionally,
   iv) an acid or chelating agent (e.g., 0.1 to 20% (e.g., 0.1 to 10%) of an acid or chelating agent disclosed herein) and/or v) a surfactant or cosolvent (e.g., 0.1 to 5% of a surfactant or cosolvent disclosed herein)
or
(b) an organic-based mixture comprising
   i) a non-polar organic solvent,
   ii) chlorine dioxide at a concentration of at least 500 ppm or 1000 ppm (e.g., at a concentration of 500 to 50,000 ppm or 1000 to 50,000 ppm, e.g., at a concentration of 1000 to 20,000 ppm, e.g., at a concentration of 1000 to 6000 ppm, e.g., at a concentration of 2500 to 3500 ppm, e.g., at a concentration of about 3000 ppm),
   iii) water (e.g., water that comprises a salt, 0.1-10%, 0.1 to 7%, or 1 to 7%, or about 2% of a salt, e.g., a salt disclosed herein, e.g., KCl), wherein the water is at a concentration of 1 to 20% (e.g., 5 to 20%, e.g., 10 to 20%) in the mixture, and, optionally
   iv) an acid or chelating agent (e.g., 0.1 to 20% (e.g., 0.1 to 10%) of an acid or chelating agent disclosed herein) and/or v) a surfactant or cosolvent (e.g., 0.1 to 5% of a surfactant or cosolvent disclosed herein).
      In some embodiments, at least the water, the chlorine dioxide, and the non-polar organic solvent are venturi mixed. In some embodiments, the water based mixture is made using a venturi with the water as the drive fluid. In some embodiments, the organic-based mixture is made using a venturi with the non-polar organic solvent as the drive fluid. The mixture or components of the mixture can have other features disclosed herein.

In some embodiments, the mixture comprises, consists essentially of, or consists of a) water (e.g., water comprising 0.1-10%, 0.1 to 7%, or 1 to 7%, or about 2% of a salt, e.g., a salt disclosed herein, e.g., KCl), b) chlorine dioxide at a concentration of at least 500 ppm or 1000 ppm (e.g., at a concentration of 500 to 20,000 ppm or 1000 to 20,000 ppm, e.g., at a concentration of 1000 to 6000 ppm, e.g., at a concentration of 2500 to 3500 ppm, e.g., at a concentration of about 3000 ppm), and c) 1-20% of a non-polar organic solvent (e.g., an organic solvent disclosed herein). Optionally, the mixture further comprises d) 0.1 to 20% (e.g., 0.1 to 10%) of an acid or chelating agent (e.g., an acid or chelating agent disclosed herein) and/or e) 0.1 to 5% of a surfactant or cosolvent (e.g., a surfactant or cosolvent disclosed herein). In some such embodiments, the mixture comprises, consists essentially of, or consists of a) water comprising 0.1-7% of a salt, b) chlorine dioxide at a concentration of 1000 to 6000 ppm, and c) 1-20% of a non-polar organic solvent; and optionally d) 0.1 to 10% of an acid or chelating agent and/or e) 0.1 to 5% of a surfactant or cosolvent (e.g., an organoether, e.g., EGMBE).

In some embodiments, the mixture comprises, consists essentially of, or consists of a) water b) chlorine dioxide at a concentration of at least 500 ppm or 1000 ppm (e.g., at a concentration of 500 to 20,000 ppm or 1000 to 20,000 ppm, e.g., at a concentration of 1000 to 6000 ppm, e.g., at a concentration of 2500 to 3500 ppm, e.g., at a concentration of about 3000 ppm), c) a non-polar organic solvent (e.g., an organic solvent at a concentration disclosed herein) and d) a salt (e.g., at a concentration of 0.1 to 10% or at a concentration disclosed herein). Optionally, the mixture further comprises d) 0.1 to 20% (e.g., 0.1 to 10%) of an acid or chelating agent (e.g., an acid or chelating agent disclosed herein) and/or e) 0.1 to 5% of a surfactant or cosolvent (e.g., a surfactant or cosolvent disclosed herein).

In some embodiments, the mixture comprises, consists essentially of, or consists of a) a non-polar organic solvent, b) chlorine dioxide at a concentration of at least 500 ppm or 1000 ppm (e.g., at a concentration of 500 to 50,000 ppm or 1000 to 50,000 ppm, e.g., at a concentration of 1000 to 20,000 ppm, e.g., at a concentration of 1000 to 6000 ppm, e.g., at a concentration of 500 to 3500 ppm, e.g., at a concentration of about 3000 ppm), c) 1-20% water (e.g., 1-20% water that comprises 0.1-10%, 0.1 to 7%, or 1 to 7%, or about 2% of a salt, e.g., a salt disclosed herein, e.g., KCl), and, optionally d) 0.1 to 20% (e.g. 0.1 to 10%) of an acid or chelating agent and/or e) 0.1 to 5% of a surfactant or cosolvent.

In some embodiments, the mixture comprises, consists essentially of, or consists of a) water, b) chlorine dioxide at a concentration of at least 200 ppm, 500 ppm or 1000 ppm (e.g., at a concentration of 200 to 20,000 ppm, 500 to 20,000 ppm, or 1000 to 20,000 ppm, e.g., at a concentration of 1000 to 6000 ppm, e.g., 2500 to 3500 ppm, e.g., about 3000 ppm), c) an organic non-polar solvent at a concentration of 0.5 to 20% (e.g., 0.5-10%, 1 to 10%, 0.5-7%, or 2.5 to 5%), d) an acid or a chelating agent at a concentration of 0.1 to 20% (e.g., 0.1 to 10%, 0.1 to 7%, or about 1 to 6%), and optionally e) EGMBE at a concentration of up to 5% (e.g., 0.1 to 5%, e.g., 0.5 to 2%). In some such embodiments, the organic non-polar solvent is xylene, cyclohexane, ethylbenzene, toluene, kerosene, diesel fuel or a mixture thereof. In some embodiments, the organic non-polar solvent is xylene. In some embodiments, the acid or chelating agent is a chelating acid. In some embodiments, the acid is acetic acid, citric acid, or a mixture thereof. In one embodiment, the acid is citric acid.

In embodiments, the water comprises a salt. In embodiments, the water comprising a salt is a brine. In embodiments, the salt comprises potassium chloride, sodium chloride, calcium chloride, potassium bromide, sodium bromide, calcium bromide, zinc bromide, ammonium chloride, potassium phosphate, sodium formate, potassium formate, cesium formate, ethyl formate, methyl formate, methyl chloro formate, triethyl orthoformate, and trimethyl orthoformate. In embodiments, the salt is selected from the group consisting of potassium chloride, sodium chloride, calcium chloride, potassium bromide, sodium bromide, calcium bromide, or zinc bromide. In embodiments, the salt is selected from the group consisting of potassium chloride, sodium chloride, calcium chloride, potassium bromide, sodium bromide, calcium bromide, zinc bromide, ammonium chloride, potassium phosphate, sodium formate, potassium formate, cesium formate, ethyl formate, methyl formate, methyl chloro formate, triethyl orthoformate, and trimethyl orthoformate. In embodiments, the salt is selected from the group consisting of potassium chloride, sodium chloride, calcium chloride, potassium bromide, sodium bromide, calcium bromide, and zinc bromide. In some embodiments, the water comprises salt at a concentration of 0.1 to 10%; 0.1 to 7%; 1 to 7%; or 1 to 5%. In one embodiment, the salt is potassium chloride. In one embodiment, the water comprises potassium chloride at a concentration of about 2%.

In some embodiments, the mixture comprises, consists of, or consists essentially of a) water (e.g., water comprising a salt, e.g., a brine), b) chlorine dioxide at a concentration of at least 500 ppm or 1000 ppm (e.g., at a concentration of 1000 to 6000 ppm, e.g., 2500 to 3500 ppm, e.g., about 3000 ppm), c) a non-polar organic solvent (e.g., an organic solvent disclosed herein, e.g., xylene) at a concentration of 0.5-10% (e.g., 1 to 10%, e.g., 1-7%, 2-7%, 3-7% or 4-7%), d) an acid or chelating agent (e.g., an acid or chelating agent disclosed herein, e.g., citric acid) at a concentration of 0.1-10% (e.g., at a concentration of 0.1 to 7%) and optionally e) EGMBE at a concentration of up to 5% (e.g., 0.1 to 5%, e.g., 0.5 to 5%, e.g., 0.5 to 2%). In some embodiments, the water is water comprising a salt, e.g., a brine. In some embodiments, the water comprises a salt (e.g., a salt disclosed herein, e.g., KCl) at a concentration of 0.1 to 7% (e.g., at a concentration of 1 to 5%, e.g., at a concentration of about 2%).

In one such embodiment, the mixture comprises, consists of, or consists essentially of a) water b) chlorine dioxide (e.g., at a concentration of 500 to 20,000 ppm, e.g., at a concentration of 1000 to 6000 ppm), c) a non-polar organic solvent at a concentration of 1 to 10% (e.g., at a concentration of 1-7%, 2-7%, 3-7% or 4-7%), d) a salt (e.g., at a concentration of 0.1 to 10% or 0.1 to 7%), e) an acid (e.g., an acid disclosed herein) at a concentration of 0.1-10% (e.g., at a concentration of 0.1-7%), and optionally f) a surfactant or cosolvent (e.g., an organoether, e.g., EGMBE) at a concentration of up to 5% (e.g., 0.1 to 5%, e.g., 0.5 to 2%). In some embodiments, the non-polar organic solvent is xylene. In some embodiments, the non-polar organic solvent is toluene.

In one such embodiment, the mixture comprises, consists of, or consists essentially of a) water comprising a salt at a concentration of 0.1 to 7%, b) chlorine dioxide at a concentration of 1000 to 6000 ppm (e.g., at a concentration of about 3000 ppm), c) a non-polar organic solvent (e.g., xylene) at a concentration of 1 to 10% (e.g., at a concentration of 1-7%, 2-7%, 3-7% or 4-7%), d) an acid (e.g., citric acid) at a concentration of 0.1-10% (e.g., at a concentration of 0.1-7%), and optionally e) EGMBE at a concentration of up to 5% (e.g., 0.1 to 5%, e.g., 0.5 to 2%).

In one embodiment, the mixture comprises, consists of, or consists essentially of a) water b) chlorine dioxide at a concentration of 1000 to 6000 ppm (e.g., at a concentration of about 3000 ppm), c) a non-polar organic solvent (e.g., xylene) at a concentration of 1 to 10% (e.g., at a concentration of 1-7%, 2-7%, 3-7% or 4-7%), d) an acid (e.g., an acid disclosed herein, e.g., citric acid) at a concentration of 0.1-10% (e.g., at a concentration of 0.1-7%), e) a salt (e.g., a salt at a concentration disclosed herein) and optionally f) EGMBE at a concentration of up to 5% (e.g., 0.1 to 5%, e.g., 0.5 to 2%).

In some embodiments, a mixture disclosed herein further comprises carbon dioxide.

In another aspect provided herein is a well (e.g., a wellbore and optionally surrounding geologic formation) into which a mixture disclosed herein has been introduced.

In another aspect provided herein is a method of treating a well, the method comprising introducing (e.g., pumping) a mixture disclosed herein into the well, e.g., into the wellbore of the well. In some embodiments, the method comprises making at least part of the mixture while the mixture is being introduced into the well. In some embodiments, the mixture is made using a method and/or apparatus disclosed herein.

In some embodiments, the method further comprises introducing carbon dioxide into the well (e.g., into the wellbore of the well). In some embodiments, the introducing of the carbon dioxide is via a separate feed (e.g., via a separate pipe that leads into the wellbore). In some embodiments, the carbon dioxide is supercritical carbon dioxide. In some embodiments, the carbon dioxide is gaseous carbon dioxide. In some embodiments, the carbon dioxide is liquid carbon dioxide.

In embodiments, the introducing comprises pumping the mixture into the well (e.g., into the wellbore of the well) at a velocity of at least 20 feet/min (6 m/min), 30 feet/min (9 m/min), 40 feet/min (12 m/min), 50 feet/min (15 m/min), 60 feet/min (15 m/min), 70 feet/min (21 m/min), 80 feet/min (24 m/min), 90 feet/min (27 m/min), or 100 feet/min (30 m/min). In embodiments, the introducing comprises pumping the mixture into the well (e.g., into the wellbore of the well) at a velocity of 50 to 30,000 feet/min (15 m/min to 9100 m/min).

In embodiments, the introducing comprises pumping the mixture into the well (e.g., into the wellbore of the well) at a velocity of 20 to 1000 feet/min (6 m/min to 305 m/min). In embodiments, the introducing comprises pumping the mixture into the well (e.g., into the wellbore of the well) at a velocity of 50 to 1000 feet/min (15 m/min to 305 m/min). In embodiments, the introducing comprises pumping the mixture into the well (e.g., into the wellbore of the well) at a velocity of 50 to 500 feet/min (15 m/min to 152 m/min).

In embodiments, the method enhances hydrocarbon recovery.

In some embodiments, the method further comprises introducing an acid or chelating agent (e.g., an acid or chelating agent disclosed herein) into the well (e.g., into the wellbore of the well). In other embodiments, the acid or chelating agent is introduced into the well (e.g., into the wellbore of the well) via a separate feed. In some such embodiments, the acid or chelating agent is introduced during the introduction of the mixture (e.g., during the introduction of the venturi-mixed mixture comprising at least water, chlorine dioxide, and an organic solvent).

In another aspect provided herein is a method of decreasing or breaking down a residue that includes hydrocarbon, the method comprising contacting the residue with a mixture disclosed herein. In some embodiments, the residue includes paraffins. In some embodiments, the residue includes asphaltenes.

In embodiments, the contacting comprises pumping the mixture at a velocity of at least 20 feet/min (6 m/min), 30 feet/min (9 m/min), 40 feet/min (12 m/min), 50 feet/min (15 m/min), 60 feet/min (15 m/min), 70 feet/min (21 m/min), 80 feet/min (24 m/min), 90 feet/min (27 m/min), or 100 feet/min (30 m/min) such that the mixture reaches the location of the residue. In embodiments, the pumping is at a velocity of 50 to 30,000 feet/min (15 m/min to 9100 m/min).

In embodiments, the contacting comprises pumping the mixture at a velocity of 20 to 1000 feet/min (6 m/min to 305 m/min). In embodiments, the contacting comprises pumping the mixture at a velocity of 50 to 1000 feet/min (15 m/min to 305 m/min). In embodiments, the contacting comprises pumping the mixture at a velocity of 50 to 500 feet/min (15 m/min to 152 m/min).

In some embodiments, the residue is located in a wellbore, or in a line (e.g., a pipe) or other equipment that is used for processing or transport of petroleum products.

In another aspect provided herein is a method of drawing out oil and/or fat (e.g., hydrocarbon) from a solid material, the method comprising contacting the solid material with a mixture disclosed herein.

The method can include other elements or features disclosed herein. For example, in some embodiments, the method comprises agitating the mixture as disclosed herein. In some embodiments, the method comprises pumping the mixture at a velocity disclosed herein.

In some embodiments, the method further comprises removing the drawn out oil and/or fat from the solid material. Typically, the removing is performed during or after the contacting. In some embodiments, the removing is performed within 6, 5, 4, 3, or 2 hours after the contacting. In some embodiments, the removing is performed within 1 hour after the contacting.

In some embodiments, the removing comprises physically or mechanically removing the oil and/or fat from the solid material. Physically or mechanically removing can be, e.g., by wiping, scraping, or otherwise moving the oil and/or fat off of the surface of the solid material. In some embodiments, physically or mechanically removing the oil and/or fat from the solid material comprises washing the solid material with a washing fluid (e.g., a washing liquid). In some embodiments, the washing fluid comprises or consists of water or an aqueous solution. In some embodiments, the washing fluid comprises or consists of a non-aqueous solvent (e.g., a non-polar organic solvent) or a non-aqueous solution. In some embodiments, the washing fluid comprises a mixture of water and a non-aqueous solvent.

In some embodiments, the removing comprises applying a chemical to the solid material to remove the oil and/or fat from the solid material. In some embodiments, the chemical is one or more of an alkali (e.g., caustic soda); a surfactant or degreasing agent; and an acid. The chemical can be dissolved in an appropriate solvent (e.g., an aqueous or non-aqueous solvent). An alkali can be used to saponify certain oils and fats (e.g., esters of glycerol and higher fatty acids). The acid can be one or a combination of acids (e.g., organic and/or inorganic acids). Inorganic acids include, e.g., sulphuric acid, nitric acid, sulfamic acid, phosphoric acid, ammonium bifluoric acid, and hydrochloric acid. Organic acids include, e.g., formic acid, citric acid, acetic acid, oxalic acid, EDTA, and DTPA. Chemicals can be applied in steps, optionally with a physical or mechanical removal step (such as, e.g., a washing step) between applications.

The removing can involve other removal methods known in the art.

As used herein, a “solid material” can be any solid material that contains an oil and/or fat.

Many solid materials can be exposed to oils and/or fats through normal use, as an incident of normal use, or by accident. In embodiments, the solid material has been exposed to an oil and/or a fat. In some embodiments, the solid material has absorbed the oil and/or the fat. In some embodiments, the solid material has been exposed to an oil and/or a fat and has absorbed the oil and/or the fat.

Some solid materials naturally contain oils and/or fats. For example, hydrocarbon bearing formations naturally contain hydrocarbon compounds, oil, and/or natural gas. In some embodiments, the solid material is a hydrocarbon bearing formation. In some embodiments, the hydrocarbon bearing formation comprises dolomite, sandstone, limestone, shale, or tar sand. In some embodiments, the hydrocarbon bearing formation comprises tar sand. In some embodiments, the hydrocarbon bearing formation comprises shale.

In some embodiments, the solid material comprises a crystalline solid. In some embodiments, the solid material comprises an amorphous solid. In some embodiments, the solid material is a crystalline solid. In some embodiments, the solid material is an amorphous solid.

In some embodiments, the solid material comprises a molecular, covalent, ionic, or metallic solid. In some embodiments, the solid material comprises a metallic solid. In some embodiments, the solid material is a molecular, covalent, ionic, or metallic solid. In some embodiments, the solid material is a metallic solid.

In some embodiments, the solid material comprises metal, rock, clay, concrete, brick, wood, plaster, drywall or a ceramic.

In some embodiments, the metal is iron or an iron alloy.

In some embodiments, the iron alloy is cast iron or steel.

In some embodiments, the solid material comprises a metal. In some embodiments, the solid material is a metal.

In some embodiments, the solid material comprises iron. In some such embodiments, the solid material comprises or consists of terra cotta, iron, or an iron alloy. In some embodiments, the iron alloy is cast iron, carbon steel, alloy steel, stainless steel, or high strength low alloy steel.

In some embodiments, the solid material comprises iron or an iron alloy. In some embodiments, the iron or iron alloy is cast iron or steel (e.g., carbon steel, alloy steel, stainless steel, or high strength low alloy steel).

In some embodiments, the iron alloy is cast iron. Cast iron is an iron-carbon alloy with a carbon content greater than 2%. Cast iron can further include silicon (e.g., 1-3% silicon) and/or other components.

In some embodiments, the iron alloy is steel. In some embodiments, the steel is carbon steel, alloy steel, stainless steel, or high strength low alloy steel.

Carbon steel is steel in which the main alloying element is carbon. It typically contains 0.04 to 2% carbon. Steel is considered to be carbon steel when no minimum content is specified or required for chromium, cobalt, columbium [niobium], molybdenum, nickel, titanium, tungsten, vanadium or zirconium, or any other element to be added to obtain a desired alloying effect; when the specified minimum for copper does not exceed 0.40 percent; or when the maximum content specified for any of the following elements does not exceed the percentages noted: manganese 1.65, silicon 0.60, copper 0.60. See www.totalmateria.com/articles/Art62.htm; accessed Dec. 15, 2015. In some embodiments, the carbon steel is a tool steel.

Alloy steel is a steel that contains other alloying elements besides carbon. The other alloying elements are added to improve its properties (e.g., strength, hardness, toughness, wear resistance, corrosion resistance, hardenability, and hot hardness) as compared to carbon steels. Such alloying elements can include, e.g., one or more of manganese, nickel, chromium, molybdenum, vanadium, silicon, boron, aluminum, cobalt, copper, cerium, niobium, titanium, tungsten, tin, zinc, lead, and/or zirconium. In some embodiments, the alloy steel is a tool steel.

Stainless steel is a steel alloy with increased corrosion resistance over that of carbon steel and alloy steel. Typically, stainless steel has a minimum of 10.5% chromium and can include other components, such as, e.g., nickel, carbon, manganese, and molybdenum.

High strength low alloy steel has 0.05-0.25% carbon content and can also include up to 2.0% manganese and small quantities of copper, nickel, niobium, nitrogen, vanadium, chromium, molybdenum, titanium, calcium, rare earth elements, and/or zirconium.

In some embodiments, the solid material comprises rock (e.g., sedimentary rock). In some embodiments, the rock is dolomite, sandstone, limestone, shale, or tar sand. In some embodiments, the solid material comprises dolomite. In some embodiments, the solid material comprises sandstone. In some embodiments, the solid material comprises limestone. In some embodiments, the solid material comprises shale. In some embodiments, the solid material comprises tar sand.

In some embodiments, the solid material comprises sedimentary rock, igneous rock, or metamorphic rock.

In some embodiments, the solid material comprises granite. In some embodiments, the rock is a hydrocarbon bearing formation. In some embodiments, the hydrocarbon bearing formation comprises dolomite, sandstone, limestone, shale, or tar sand. In some embodiments, the hydrocarbon bearing formation comprises tar sand. In some embodiments, the hydrocarbon bearing formation comprises shale.

In some embodiments, the solid material comprises clay.

In some embodiments, the solid material comprises concrete.

In some embodiments, the solid material comprises brick.

In some embodiments, the solid material comprises wood.

In some embodiments, the solid material comprises plaster.

In some embodiments, the solid material comprises drywall (also known as plasterboard).

In some embodiments, the solid material comprises a ceramic. In some such embodiments, the solid material comprises terra cotta. In some embodiments, the solid material is metal, rock, clay, concrete, brick, wood, plaster, drywall or a ceramic.

The oil and/or fat is typically a substance or combination of substances that is not water soluble or has low solubility in water. In some embodiments, the oil and/or fat has a water solubility of less than or equal to 0.5 g/100 g. In some embodiments, the oil and/or fat has a water solubility of less than or equal to 0.1 g/100 g. In some embodiments, the oil and/or fat includes or is composed primarily of one or more hydrocarbon compounds. In some embodiments, the oil and/or fat is a liquid at 20° C. or has a melting point of 80° C. or less (at a pressure of 760 mm Hg). In some embodiments, the oil and/or fat is a liquid at 20° C. or has a melting point of 50° C. or less (at a pressure of 760 mm Hg). Typically, the oil and/or fat will leave a greasy stain if applied to white paper.

In some embodiments, the oil and/or fat comprises one or more hydrocarbon compounds made up of hydrogen and carbon. In some embodiments, the oil and/or fat consists primarily of hydrocarbon compounds.

In some embodiments, the oil and/or fat comprises a hydrocarbon (e.g., one or more hydrocarbon compounds made up of hydrogen and carbon).

In some embodiments, the oil or fat is a hydrocarbon (e.g., one or more hydrocarbon compounds made up of hydrogen and carbon).

In some embodiments, the oil is motor oil (e.g., light motor oil or heavy motor oil).

In embodiments, the oil is a synthetic oil.

In embodiments, the oil and/or fat is a plant-derived oil or fat.

In some embodiments, oil and/or fat is an animal-derived oil or fat.

In embodiments, the oil and/or fat is a cooking oil or fat. A cooking oil or fat can be any plant-derived, animal-derived or synthetic oil or fat used in cooking. Plant-derived oils and fats used in cooking include, e.g., olive oil, palm oil, palm kernel oil, soybean oil, canola oil (rapeseed oil), corn oil, sunflower oil, safflower oil, peanut oil, sesame oil, coconut oil, hemp oil, almond oil, macadamia nut oil, cocoa butter, avocado oil, cottonseed oil, and wheat germ oil Animal-derived oils or fats used in cooking include, e.g., pig fat (lard), poultry fat, beef fat, lamb fat, and fat derived from milk (e.g., butter or ghee).

In some embodiments, the oil and/or fat comprises a fatty acid. In some embodiments, the oil and/or fat comprises a fatty acid ester. In some embodiments, the oil and/or fat is a fatty acid or fatty acid ester.

In some embodiments, the solid material is a hydrocarbon bearing formation. In some embodiments, the solid material is a line or other equipment that is used for processing or transport of petroleum products. In some embodiments, the solid material is a petroleum tanker, e.g., a crude tanker (e.g., an ultra large crude carrier) or a product tanker.

In another aspect provided herein is a method of making a mixture, the method comprising (i) venturi mixing a first component and a second component and, concurrently or subsequently, (ii) venturi mixing a third component with the first and/or second component, wherein the first component, the second component and the third component are different and selected from water, chlorine dioxide and organic non-polar solvent.

In another aspect provided herein is a method of making a mixture, the method comprising educting into a venturi that uses a first fluid as its drive fluid (i) chlorine dioxide and (ii) a second fluid, thereby forming a mixture comprising the first fluid, the chlorine dioxide, and the second fluid, wherein the first fluid is water (e.g., water comprising a salt (e.g., at a concentration of disclosed herein), e.g., a brine) and the second fluid is an organic non-polar solvent, or wherein the first fluid is an organic non-polar solvent and the second fluid is water (e.g., water comprising a salt (e.g., at a concentration of disclosed herein), e.g., a brine). The mixture can comprise components and/or concentrations of components or have other features specified elsewhere herein.

In some embodiments, the method comprises introducing additional components disclosed herein (e.g., an acid or chelating agent and/or a surfactant or cosolvent) by educting the additional components into the venturi. In other embodiments, the method comprises introducing the additional components by other means.

In some embodiments, the method further comprises introducing one or more additional components (e.g, an acid or chelating agent, and/or a surfactant or cosolvent) into the mixture. The one or more additional components can each independently be added by (i) educting the component into the venturi (e.g., by including the component as part of the second fluid or by educting the component separately), (ii) by introducing the component into the drive fluid (e.g., before the drive fluid enters the venturi), or (iii) by adding the component to the initial portion of the mixture that comprises the first fluid, the chlorine dioxide, and the second fluid after the initial portion of the mixture exits the venturi.

To form a mixture that comprises an acid or chelating agent, an acid or chelant releasing agent (e.g., a powder, e.g., citric acid powder) can optionally be employed. Typically, the acid or chelant releasing agent (e.g., a powder, such as, e.g., citric acid powder) is added to a liquid (typically water) to form an acid solution (typically an aqueous solution). For example, the acid or chelant releasing agent can be introduced into the drive fluid (e.g., before the drive fluid enters the venturi) or the second fluid. The acid or chelant releasing agent can also be introduced into a separate liquid (e.g., water) to form a solution (e.g., an aqueous solution) of the acid or chelating agent that is introduced into the mixture. Such a solution of the acid or chelating agent can be introduced, e.g., by educting it into the venturi, or by adding it to the initial portion of the mixture that comprises the first fluid, the chlorine dioxide, and the second fluid after the initial portion of the mixture exits the venturi.

In another aspect provided herein is a method of making a mixture, the method comprising educting into a venturi that uses a first fluid as its drive fluid (i) chlorine dioxide and (ii) a second fluid, and, optionally (iii) an acid or chelating agent, and/or (iv) a surfactant or cosolvent; thereby forming a mixture comprising the first fluid, the chlorine dioxide, and the second fluid, and, optionally, the acid or chelating agent and/or the surfactant or cosolvent. The mixture can comprise components and/or concentrations of components or have other features specified elsewhere herein.

In some embodiments, the first fluid is water (e.g., water comprising a salt (e.g., at a concentration of disclosed herein), e.g., a brine) and the second fluid is an organic non-polar solvent.

In some such embodiments, the mixture comprises the chlorine dioxide at a concentration of at least 200 ppm, 500 ppm or 1000 ppm (e.g., 200 to 20,000 ppm, 500 to 20,000 ppm, 1000 to 20,000 ppm, e.g. 1000 to 6000 ppm, e.g., 2500 to 3500 ppm) and the organic non-polar solvent at a concentration of 0.1 to 20% (e.g., 1 to 20%, e.g., 1 to 10%, e.g., 1 to 7%, 2.5% to 5%, 2 to 7%, 3 to 7%, or 4 to 7%). The mixture can comprise the acid or chelating agent at a concentration of 0-20% (e.g., at a concentration of 0.1-20% or 0.1 to 10%) and/or the surfactant or cosolvent at a concentration of 0-5% (e.g., at a concentration of 0.1 to 5%).

In other embodiments, the first fluid is an organic non-polar solvent and the second fluid is water (e.g., water comprising a salt (e.g., at a concentration of disclosed herein), e.g., a brine). In some such embodiments, the mixture comprises the chlorine dioxide at a concentration of at least 200 ppm, 500 ppm, or 1000 ppm (e.g., 200 to 50,000 ppm, 200 to 20,000 ppm, 500 to 50,000 ppm, 1000 to 50,000 ppm, 1000 to 20,000 ppm, 1000 to 6000 ppm, or 2500 to 3500 ppm) and the water at a concentration of 1-20% (e.g., 1 to 10%, 5 to 20%, or 10 to 20%). The mixture can comprise the acid or chelating agent at a concentration of 0-20% (e.g., at a concentration of 0.1-20% or 0.1 to 10%) and/or the surfactant or cosolvent at a concentration of 0-5% (e.g., at a concentration of 0.1 to 5%).

In another aspect provided herein is a method of making a mixture, the method comprising educting into a venturi that uses water (e.g., water comprising 0.1-7% of a salt) as its drive fluid (i) chlorine dioxide and (ii) an organic non-polar solvent, and optionally (iii) an acid or chelating agent, and/or (iv) a surfactant or cosolvent; thereby forming a mixture comprising the water, the chlorine dioxide, and the organic solvent, and optionally the acid or chelating agent and/or the surfactant or cosolvent. The mixture can comprise components and/or concentrations of components or have other features specified elsewhere herein.

In some embodiments, the mixture comprises the chlorine dioxide at a concentration of at least 500 ppm or 1000 ppm, the organic non-polar solvent at a concentration of 0.1 to 20% (e.g., 1 to 20%, e.g., 1 to 10%, e.g., 1 to 7%, 2.5% to 5%, 2 to 7%, 3 to 7%, or 4 to 7%) and optionally the acid or chelating agent at a concentration of 0.1-20% (e.g., 0.1 to 20%, e.g., 0.1 to 10%) and/or the surfactant or cosolvent at a concentration of 0.1-5%.

In another aspect provided herein is a method of making a mixture, the method comprising educting into a venturi that uses an organic non-polar solvent as its drive fluid (i) chlorine dioxide and (ii) water (e.g., water comprising 0.1-7% of a salt), and optionally (iii) an acid or chelating agent and/or (iv) a surfactant or cosolvent; thereby forming a mixture comprising the organic non-polar solvent, the chlorine dioxide, and the water, and optionally the acid or chelating agent and/or the surfactant or cosolvent. The mixture can comprise components and/or concentrations of components or have other features specified elsewhere herein.

In some embodiments, the mixture comprises the chlorine dioxide at a concentration of at least 200 ppm. In some embodiments, the mixture comprises the chlorine dioxide at a concentration of at least 500 ppm. In some embodiments, the mixture comprises the chlorine dioxide at a concentration of at least 1000 ppm. In some embodiments, the mixture comprises the water at a concentration of 0.1 to 20%, 1 to 20%, 5% to 20%, or 10% to 20%. In some embodiments, the mixture optionally comprises the acid or chelating agent at a concentration of 0.1-20% (e.g., 0.1 to 20%, e.g., 0.1 to 10%) and/or the surfactant or cosolvent at a concentration of 0.1-5%.

In some such embodiments, an acid or chelating agent is added to a venturi mixed mixture disclosed herein (e.g., a venturi mixed mixture comprising water (e.g., water comprising a salt), chlorine dioxide, and an organic solvent) prior to or during the introduction of the venturi-mixed mixture into the well. In some embodiments, the acid or chelating agent is not educted into the venturi but is added to the mixture after it exits the venturi.

In another aspect provided herein is a method of making a mixture, the method comprising educting into a venturi that uses a first fluid as its drive fluid (i) chlorine dioxide, (ii) a second fluid, and (iii) an acid or chelating agent, and optionally (iv) a surfactant or cosolvent; thereby forming a mixture comprising the first fluid, the chlorine dioxide, the second fluid, and the acid or chelating agent, and optionally the surfactant or cosolvent. In some embodiments, the first fluid is water (e.g., water comprising a salt, e.g., a brine) and the second fluid is an organic non-polar solvent, and in other embodiments, the first fluid is an organic non-polar solvent and the second fluid is water. The mixture can comprise components and/or concentrations of components or have other features specified elsewhere herein.

In some embodiments, the first fluid is water (e.g., water comprising a salt, e.g., a brine) and the second fluid is an organic non-polar solvent. In some such embodiments, the mixture comprises the chlorine dioxide at a concentration of at least 200 ppm, 500 ppm, or 1000 ppm; the organic non-polar solvent at a concentration of up to 20% (e.g., 0.1 to 20%, 1 to 20%, 1 to 10%, 1 to 7%, 2.5% to 5%, 2 to 7%, 3 to 7%, or 4 to 7%); the acid or chelating agent at a concentration of up to 20% (e.g., 0.1 to 20%, e.g., 0.1 to 10%); and optionally the surfactant or cosolvent at a concentration of 0-5% (e.g., 0.1 to 5%).

In other embodiments, the first fluid is an organic non-polar solvent and the second fluid is water (e.g., water comprising a salt, e.g., a brine). In some such embodiments, the mixture comprises the chlorine dioxide at a concentration of at least 200 ppm, 500 ppm, or 1000 ppm; the water at a concentration of up to 20% (e.g., 0.1 to 20%, 1 to 20%, 5% to 20%, or 10% to 20%); the acid or chelating agent at a concentration of up to 20% up to 20% (e.g., 0.1 to 20%, e.g., 0.1 to 10%); and optionally the surfactant or cosolvent at a concentration of 0-5% (e.g., 0.1 to 5%).

Also provided herein is a mixture made according to a method disclosed herein.

Mixing Apparatus and Generation of Chlorine Dioxide

An apparatus and methods for generation of chlorine dioxide are described in U.S. Pat. Nos. 6,468,479 and 6,645,457, the entire contents of each of which are hereby incorporated herein by reference. The chlorine dioxide can be generated according to such methods, and/or according to other methods known in the art.

Also provided herein is a venturi mixing apparatus for making a mixture including water, chlorine dioxide, and an organic non-polar solvent. The apparatus can be used for mixing the water, chlorine dioxide, and organic non-polar solvent, optionally together with other components (e.g., other components of a mixture as disclosed herein), such as, e.g., an acid or chelating agent, and/or a surfactant or cosolvent. The apparatus comprises (a) an eductor comprising a tube having an inlet for a drive fluid, an outlet for a drive fluid, a constriction between the inlet and the outlet, and an opening in the area of the constriction; and (b) a column in fluid communication with the opening, the column comprising (i) an inlet for chlorine dioxide or inlets for chlorine dioxide precursor chemicals and (ii) an inlet through which a second fluid can enter the column. In some embodiments, the drive fluid is water and the second fluid is the organic non-polar solvent. In alternative embodiments, the drive fluid is the organic non-polar solvent and the second fluid is water. In some embodiments, the apparatus further comprises one or more additional inlets for other components. In some such embodiments, the column comprises an inlet through which an acid or chelating agent can enter the column and/or an inlet through which a surfactant or cosolvent can enter the column.

As used herein, the opening that is in the “area of the constriction” is in the area of the tube where a person of skill in the art would expect suction to be created when fluid flows through the eductor. In a preferred embodiment, the opening comprises the area where the tube is most constricted and where one would expect the most suction to be created.

In embodiments, the column comprises inlets for chlorine dioxide precursor chemicals. In one embodiment, the precursors are chlorine gas (Cl₂) and an aqueous solution of sodium chlorite (NaClO₂). In another embodiment, the precursor chemicals include sodium hypochlorite (NaOCl) and hydrochloric acid (HCl), which are used to generate chlorine gas (Cl₂).

Also provided herein is a venturi mixing apparatus suitable for mixing water, chlorine dioxide, an organic non-polar solvent and an acid or chelating agent, the apparatus comprising (a) an eductor comprising a tube having an inlet for a drive fluid, an outlet for a drive fluid, a constriction between the inlet and the outlet, and an opening in the area of the constriction; and (b) a column in fluid communication with the opening, the column comprising (i) an inlet for chlorine dioxide or inlets for chlorine dioxide precursor chemicals; (ii) an inlet through which a second fluid can enter the column, and (iii) an inlet through which an acid or chelating agent can enter the column, (iv) and optionally an inlet through which a surfactant or cosolvent can enter the column; wherein the drive fluid is selected from water and an organic solvent, wherein the second fluid is an organic solvent when the drive fluid is water and the second fluid is water when the drive fluid is an organic solvent. In some embodiments, the column further comprises an inlet through which a surfactant or cosolvent can enter the column. In some embodiments, the drive fluid is water and the second fluid is an organic solvent. In some embodiments, the drive fluid is an organic solvent and the second fluid is water.

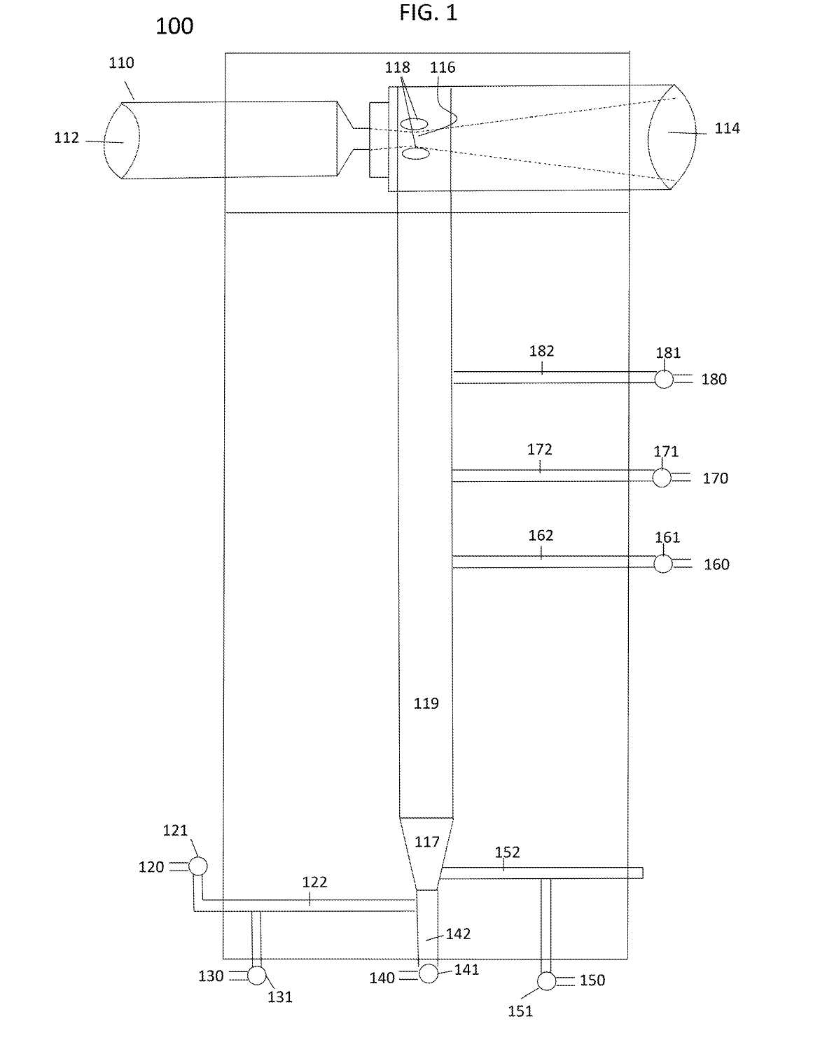

An exemplary apparatus is shown in FIG. 1. The venturi mixing apparatus 100 comprises an eductor or venturi 110 comprising a tube having an inlet 112 for a drive fluid, an outlet 114 for a drive fluid, a constriction 116 between the inlet and the outlet, and opening(s) 118 in the area of the constriction. A drive fluid is flowed (e.g., pumped) into inlet 112. The eductor creates a vacuum that functions to draw components of the mixture, including chlorine dioxide, into column 119. Typically, chlorine dioxide is generated in the apparatus by reacting precursor chemicals to form chlorine dioxide. Inlets 120, 130, 1140, and 150 can be adjusted by precision metering valves 121, 131, 141, and 151 to achieve the desired flow rate of chlorine dioxide precursor chemicals. As an alternative to using chlorine dioxide precursor chemicals to produce chlorine dioxide within the apparatus, chlorine dioxide can be generated with a separate system and fed directly into the lower part of column 119.

In one embodiment, the chlorine dioxide precursor chemicals are chlorine (Cl₂) gas and an aqueous solution of sodium chlorite (NaClO₂) (e.g., a solution of 25% sodium chlorite). The chlorine is drawn in through inlet 130 and valve 131 such that the chlorine flows through passage 122 and upwardly into transition zone 117. The sodium chlorite solution is drawn in through inlet 150 and valve 151 such that the solution flows through passage 152 into the lower part of transition zone 117, where the sodium chlorite reacts with chlorine to form chlorine dioxide. The chlorine dioxide flows upward into column 119.

In another embodiment, the chlorine dioxide precursor chemicals are sodium hypochlorite (NaOCl), acid (e.g., hydrochloric acid (HCl)), and an aqueous solution of sodium chlorite (NaClO₂) (e.g., a solution of 25% sodium chlorite). In this embodiment, passage 142 is connected to a metering valve 141 and an inlet 140. The NaOCl is drawn in through inlet 120 and valve 121 into passage 122. An aqueous solution of acid (typically HCl) is drawn into inlet 140 and valve 141 into passage 142. The NaOCl and acid meet at a location below the transition zone and quickly react to from chlorine (Cl₂) gas. The Cl₂ flows upwardly through the transition zone 117. Sodium chlorite solution is drawn into inlet 150 through valve 151 such that the solution flows through passage 152 into the lower part of transition zone 117, where the sodium chlorite reacts with the chlorine to form chlorine dioxide. The chlorine dioxide flows upward into column 119.

The apparatus includes at least one additional inlet 160, valve 161, and passage 162 that can be used to draw in a second fluid. The second fluid enters the column above the level of the transition zone 117. The second fluid is educted upwards through the column, together with the chlorine dioxide, and is then drawn through opening 118 into the eductor, where the drive fluid, second fluid, and chlorine dioxide are combined to form a mixture (e.g., a homogeneous mixture) as disclosed herein.

Typically, the drive fluid for the venturi is water and the second fluid is a non-polar organic solvent, or the drive fluid is a non-polar organic solvent and the second fluid is water. Accordingly, the mixing apparatus serves to mix chlorine dioxide with the water and non-polar organic solvent to form a mixture, e.g., a mixture that is homogenous, e.g., as disclosed herein.

In some embodiments, a mixture as disclosed herein that comprises water, chlorine dioxide, and a non-polar organic solvent also includes other components. In some embodiments, one or more other components also undergo venturi mixing using the mixing apparatus.

Addition of other components that undergo venturi mixing can be, for example, by eduction into the column of the disclosed mixing apparatus through additional inlets as described herein. Addition of other components that undergo venturi mixing can also be, for example, by addition to the drive fluid (e.g., prior to entry of the drive fluid into the venturi) or to the second fluid. The other components can be, e.g., components disclosed herein (such as, e.g., an acid or chelating agent and/or a surfactant or cosolvent) or other components of well treatments that are known in the art.

Addition of other components that are mixed by the mixing apparatus can also be, for example, by eduction into the column of the mixing apparatus through one or more additional inlets, valves and passages. Optionally, the apparatus includes one or more additional inlets, valves, and passages that can be used to introduce additional components to be included in a mixture. The components can be introduced individually through separate inlets, or when feasible, two or more components of a mixture can be combined and introduced through a single inlet. For example, one or more additional components of the mixture (e.g., an acid or chelating agent and/or a surfactant or cosolvent) can be introduced into the second fluid and educted into the column of the mixing apparatus together with the second fluid. Alternatively, one or more additional components of the mixture (e.g., an acid or chelating agent and/or a surfactant or cosolvent) can included as part of a separate solution that is educted into the column of the mixing apparatus.

As an example, another component (e.g., an acid or chelating agent (e.g., citric acid)) can be educted into additional inlet 170 through additional valve 171 and into additional passage 172. Optionally, another component (e.g., a surfactant or cosolvent (e.g., EGMBE)) can be independently educted into another inlet (e.g., additional inlet 180), valve (e.g., valve 181) and passage (e.g., passage 182). Each of the additional inlets and the respective connected valves and passages can be located anywhere on column 119, above the transition zone 117 where the chlorine dioxide forms or enters the column. The components educted through the additional inlets, valves, and passages travel upwards through column 119 and into the venturi 110. The force provided by the venturi results in mixing (also referred to herein as “venturi mixing”) of the drive fluid with the chlorine dioxide, the second fluid, and any other components of the mixture that have been educted into the column (e.g., by addition to the drive fluid or another fluid that is educted into the column) or introduced into the drive fluid (e.g., before the drive fluid enters the venturi).

All relevant teachings of the documents cited herein are hereby incorporated herein by reference.

### EXAMPLES

### Example 1: Preparation of Homogenous Mixture of Incompatible Materials

This example illustrates preparation of a homogenous mixture of chlorine dioxide in incompatible materials.

A pump drew an aqueous solution comprising 2% potassium chloride from a 500 barrel Frak tank. The pump raised the pressure sufficiently to drive a venturi (eductor) at four barrels per minute. The venturi powered a chlorine dioxide generator (see U.S. Pat. No. 6,468,479) and provided a motive force that drew additional mixture components through secondary ports into the reaction column of the generator after the reactant zone where the chlorine dioxide formed. Precursors were fed into the generator to make chlorine dioxide at such a rate as to result in a 3000 mg/L solution of chlorine dioxide. Xylene was drawn into a secondary port at such a rate as to achieve a 5% final concentration of xylene in the mixture that was created. Also drawn into a secondary port was a 50% solution of citric acid at such a rate as to achieve a final concentration of 2% in the mixture that was created. Additionally a solution of ethylene glycol mono butyl ether was drawn into a secondary port at such a rate as to achieve a final concentration of 2% in the mixture. Accordingly, a mixture of (i) 3000 mg/L chlorine dioxide, (ii) water comprising 2% potassium chloride, (iii) 5% xylene, (iv) 2% citric acid, and (v) 2% ethylene glycol monobutyl ether (EGMBE) was made with the venturi driven generator.

A mixture having the same components in the same amounts was created by hand on the laboratory bench and blended using a high shear prop blender.

The mixtures made using the two different methods were compared. The laboratory created samples separated off into distinct oil and water phases within five minutes of creation. In contrast, samples created through the venturi drive system remained substantially homogenous for a temporary period of at least about 60 minutes, that is, they did not show significant visible separation. If allowed to stand for several hours, however, these samples would also separate.

### Example 2: Study of Homogenous Mixture of Incompatible Materials

To investigate whether EGMBE was responsible for the temporary homogeneity of the mixture of incompatible materials that was created in Example 1, the same mixture was created without the EGMBE.

A pump drew an aqueous solution of 2% potassium chloride from a 500 barrel Frak tank. The pump raised the pressure sufficiently to drive a venturi at four barrels per minute. The venturi powered a chlorine dioxide generator (see U.S. Pat. No. 6,468,479) and provided a motive force that drew additional mixture components through secondary ports into the reaction column of the generator after the reactant zone where the chlorine dioxide formed. Precursors were fed into the generator to make chlorine dioxide at such a rate as to result in a 3000 mg/L solution of chlorine dioxide. Xylene was drawn into a secondary port at such a rate as to achieve a 5% final concentration of xylene in the mixture that was created. Also drawn into a secondary port was a 50% solution of citric acid at such a rate as to achieve a final concentration of 2% in the mixture.

A mixture having the same components in the same amounts was created by hand on the laboratory bench and blended using a high shear prop blender.

The samples made using the two different methods were compared. The laboratory created samples separated off into distinct oil and water phases within five minutes of creation. The samples created through the venturi drive system remained substantially homogenous for 60 minutes, that is, they did not show significant visible separation. If allowed to stand for several hours, however, these samples would also separate.

These results indicate that EGMBE was not responsible for the temporary homogeneity of the mixture of incompatible materials that was created in Example 1.

### Example 3: Study of Homogenous Mixture of Incompatible Materials

To investigate whether citric acid was responsible for the temporary homogeneity of the mixtures of incompatible materials that were created in Example 1 and Example 2, a mixture was created as in Example 2 except that the mixture did not include citric acid.

A pump drew an aqueous solution of 2% potassium chloride from a 500 barrel Frak tank. The pump raised the pressure sufficiently to drive a venturi at four barrels per minute. The venturi powered a chlorine dioxide generator (see U.S. Pat. No. 6,468,479) and provided a motive force that drew an additional mixture component (xylene) through a secondary port into the reaction column of the generator after the reactant zone where the chlorine dioxide formed. Precursors were fed into the generator to make chlorine dioxide at such a rate as to result in a 3000 mg/L solution of chlorine dioxide. Xylene was drawn into a secondary port at such a rate as to achieve a 5% final concentration of xylene in the mixture.

A mixture having the same components in the same amounts was created by hand on the laboratory bench and blended using a high shear prop blender.

The samples made using the two different methods were compared. The laboratory created samples separated off into distinct oil and water phases within five minutes of creation. The samples created through the venturi drive system remained substantially homogenous for 60 minutes, that is, they did not show significant visible separation. If allowed to stand for several hours, however, these samples would also separate.

These results indicate that neither citric acid nor EGMBE was responsible for the temporary homogeneity of the mixture of incompatible materials that was created in Example 1.

### Example 4: Mixture of Incompatible Materials

To investigate whether chlorine dioxide was responsible for the transient homogeneity of the mixture of incompatible materials that was created in Examples 1 to 3, a mixture was created as in Example 3 except that the mixture did not include chlorine dioxide.

A pump drew an aqueous solution of 2% potassium chloride from a 500 barrel Frak tank. The pump raised the pressure sufficiently to drive a venturi at four barrels per minute. Xylene was drawn into a secondary port at such a rate as to achieve a 5% final solution concentration of xylene.

A mixture having the same components in the same amounts was created by hand on the laboratory bench and blended using a high shear prop blender.

The samples made using the two different methods were compared. The laboratory and venturi drive system created samples separated off into distinct oil and water phases within five minutes of creation.

The results of this Example indicate that in absence of chlorine dioxide, the venturi-mixed mixture of an aqueous solution and organic solvent (xylene) does not show the same temporary homogeneity that was observed in the mixtures created in Examples 1 to 3. Accordingly, the presence of chlorine dioxide is critical for the temporary homogeneity of the mixtures that were made in Examples 1 to 3.

### Example 5: Treating Well with Mixture of Incompatible Materials Enhanced Oil and Gas Production

A well that had experienced a 90% reduction in its gas production over its 12 month operational lifespan was treated using a mixture created with the venturi drive system.

Production of Mixture

A pump drew an aqueous solution of 2% potassium chloride from a 500 barrel Frak tank. The pump raised the pressure sufficiently to drive a venturi at four to eight barrels per minute. The venturi powered a chlorine dioxide generator (see U.S. Pat. No. 6,468,479) and provided a motive force that drew additional mixture components through secondary ports into the reaction column of the generator after the reactant zone where the chlorine dioxide formed. Precursors were fed to make chlorine dioxide at such a rate as to result in a 3000 mg/L (3000 ppm) solution of chlorine dioxide. Xylene was drawn into a secondary port at such a rate as to achieve a 5% final concentration of xylene in the mixture that was created. Also drawn into a secondary port was a 50% solution of citric acid at such a rate as to achieve a final concentration of 2% in the mixture. Additionally a solution of ethylene glycol mono butyl ether was drawn into a secondary port at such a rate as to achieve a final concentration of 2% in the mixture.

Well History

Previous attempts to treat this well with an aqueous solution of chlorine dioxide were not successful. Xylene treatments (without chlorine dioxide) in volumes over 20 times that used in this present example had been employed to treat the well; those treatments required high temperature application to be successful for removal of paraffin damage. The effect of the xylene treatments was short-lived; subsequently, the well production dropped to about 1/10^{th} of its initial production. Conventional HCl treatments and various citric acid blends had also proven unsuccessful in the treatment of this well.

Well Treatment

The mixture created using the venturi drive system was fed into the suction of a high-pressure pump truck. The mixture was then pumped down the annular space of a producing gas well. The total fluid volume of the mixture used to treat this well was typical of a conventional acidizing treatment. The mixture was applied similarly via six stages using ball drop diverters. Following the treatment the well was shut in for approximately 4 hours and then returned to production.

Results

Approximately 24 hours was required for the fluid load to be returned and gas production to resume. Upon removal of the fluid load, gas production levels were at 140% of the original drilled production value. While the original oil production on this well was minimal, the volume of oil production was increased by almost 300%. Production levels remained steady for approximately 30 days, with an ensuing rate of decline normal for that formation and field.

### Example 6: Treating Well with Mixture of Incompatible Materials Enhanced Oil Production

This Example provides average results for five wells treated in a common formation and geography.

A pump drew an aqueous solution of 2% potassium chloride from a 500 barrel Frak tank. The pump raised the pressure sufficiently to drive a venturi at four to eight barrels per minute. The venturi powered a chlorine dioxide dioxide generator (see U.S. Pat. No. 6,468,479) and provided a motive force that drew additional mixture components through secondary ports into the reaction column of the generator after the reactant zone where the chlorine dioxide formed. Precursors were fed into the generator to make chlorine dioxide at such a rate as to result in a 3000 mg/L (3000 ppm) solution of chlorine dioxide. Xylene was drawn into a secondary port at such a rate as to achieve a 2.5% final concentration of xylene in the mixture that was created. Also drawn into a secondary port was a 50% solution of citric acid at such a rate to achieve a final concentration of 5% in the mixture. Additionally a solution of ethylene glycol mono butyl ether was drawn into a secondary port at such a rate to achieve a final concentration of 1% in the mixture.

The mixture was fed into the suction of a high-pressure pump truck. The mixture was then pumped down the annular space of a rod pump based producing oil well. Prior to beginning the job the pump and flowline were shut in. The mixture was pumped at the maximum rate possible by the two pumping trucks, in this case kill trucks, at approximately 7 barrels per minute. A total volume of approximately 200 barrels was fed into the vertical well with a production zone of about 125 feet in a single stage. While initially a pumping pressure of approximately 300 psi was required, after about 50 barrels the well went on vacuum. At a pumping volume of approximately 150 barrels the well began to pressure up indicating loading of the wellbore and good coverage across the formation. Once the 200 barrels was fed the fluid column was displaced to depth with 2% brine. The wells were shut in overnight and then returned to production. Well performance was monitored and pumping was increased to maintain the same fluid level as before the treatment.

The results are shown in Table 2. During the initial 30 days following the treatment, the baseline production of oil was increased by over 400%. Over the next six months these production rates stabilized at approximately 32% over baseline. Additionally the average oil cut of the produced fluids increased by 7.4% during the initial six months.

TABLE 2

| | | | Initial | | | |
|---|---|---|---|---|---|---|
| | | | 30 | | Month | |
| | | | Days | | 2 to 6 | |
| | Baseline | | Avg | | Average | |
| Well ID | BOPD | BWPD | BOPD | BWPD | BOPD | BWPD |
| S1 | 17 | 326 | 87 | 1263 | 24 | 373 |
| S2 | 5 | 126 | 30 | 477 | 8 | 147 |
| S3 | 7 | 163 | 32 | 880 | 8 | 213 |
| S4 | 11 | 217 | 34 | 917 | 15 | 267 |
| S5 | 14 | 297 | 51 | 1450 | 17 | 369 |
| total | 54 | 1129 | 234 | 4987 | 72 | 1369 |
| AVG Oil | | 4.78% | | 4.69% | | 5.26% |
| Cut | | | | | | |
| % | | | 433% | 442% | 133% | 121% |
| enhancement | | | | | | |
| over | | | | | | |
| baseline | | | | | | |

BOPD: barrels of oil per day
BWPD: barrels of water per day

### Example 7: Exposing a Core from a Wellbore to Chlorine Dioxide Draws Out Hydrocarbons

To investigate the effect of chlorine dioxide gas on a hydrocarbon bearing formation, a dolomite core taken from a wellbore of an oil and gas well was exposed to chlorine dioxide. The core was cut into approximately 0.5 cm slices. The slices were then broken into halves. Half of each slice was fumigated (experimental slice) and the other half (control slice) was left sitting in the open air as a control. Prior to the fumigation, all of the slices were completely dry and did not release any oil.

For the fumigation, a container was partially filled with an aqueous solution of approximately 4000 ppm (w/w) chlorine dioxide. A rack was placed in the container and an experimental slice was placed on the rack. The experimental slice did not come into contact with the solution. The container was closed so that the liquid chlorine dioxide solution would release chlorine dioxide gas into the headspace. It is estimated that approximately 15,000 ppm, of chlorine dioxide was released into the headspace. The container was kept in the dark, except that the container was taken into the light and opened once per day for 10 days to observe the experimental slice and take pictures. The liquid solution evaporated after 10 days.

The experimental slices showed a uniform visible sheen of oil after 1 day of chlorine dioxide exposure. The experimental slice also turned a reddish color due to oxidation of the iron content of the core. During the course of the 10-day experiment, heavier hydrocarbons began to exude and form localized pools of oil over the sheen. The control slices were completely dry and showed no change over time.

These results show that chlorine dioxide is effective in drawing out hydrocarbon from a hydrocarbon bearing formation. Because it is known that chlorine dioxide can be helpful in removing damage from a wellbore, chlorine dioxide dissolved in water has been used in the past to treat damaged wellbores. However, the present result, which shows that an undamaged core exuded hydrocarbons in response to chlorine dioxide exposure, was entirely unexpected.

This experiment indicates that chlorine dioxide well treatments that target areas of a hydrocarbon bearing formation extending beyond the near wellbore region can improve hydrocarbon recovery even more than conventional liquid treatments that have targeted only the wellbore or near wellbore region. Chlorine dioxide can be delivered to areas extending beyond the near wellbore region for example by introducing chlorine dioxide in a fluid volume calculated such that when the fluid is introduced into the well, the fluid is expected to extend to a radius that goes beyond the near wellbore region.

### Example 8: Exposing Solid Materials to Chlorine Dioxide Draws Out Oils

To investigate the ability of chlorine dioxide to draw out oils from other kinds of solid materials, various solid materials were soaked in various kinds of oils and subsequently exposed to chlorine dioxide. The solid materials that were used were cast iron, stainless steel, and terra cotta. Two samples of each material (an experimental example that was subsequently subjected to fumigation and a control that was subsequently left out in the air) were soaked in light motor oil (SAE 5W20), heavy motor oil (SAE40), heavy mineral oil, lightweight paraffin oil (lamp oil), grapeseed oil, or peanut oil. The terra cotta was soaked overnight (ca. 12 hours). The stainless steel and cast iron were soaked for 1 week.

Prior to the fumigation, the experimental and control samples were wiped off so that no oil could be felt or observed on the surface; the surfaces were dry to touch. For the fumigation, a container was partially filled with 2 gallons of an aqueous solution of approximately 6600 ppm (w/w) chlorine dioxide. A rack was placed in the container and an experimental sample of each material that had been soaked in each type of material (18 experimental samples) was placed on the rack. The experimental samples did not come into contact with the solution. The container was closed so that the liquid chlorine dioxide solution would release chlorine dioxide gas into the headspace. It is estimated that approximately 20,000 ppmv of chlorine dioxide was released into the headspace. The container was kept in the dark for one week without opening the container. The set of 18 control samples were exposed to the ambient air during the one week period.

After the one week fumigation period, the following effects were observed for all types of oils. The surface of the treated cast iron samples had oxidized (rusted) and oil exuded from the material, mixing with the rust to form a paste. The control cast iron samples showed no change and the surfaces felt dry to touch. The treated stainless steel samples exuded oil that formed a continuous layer on the surface. The control stainless steel samples showed no change and the surfaces felt dry to touch. Four of the six experimental terra cotta samples had a consistently visible sheen of oil on the surface. The heavy mineral oil and paraffin lamp oil samples exuded oil in bead-like droplets on the surface. The control terra cotta samples showed no change and the surfaces felt dry to touch. Following the fumigation period, all samples were left out in the laboratory overnight. The next day, the experimental samples had reabsorbed most of the oil.

These results show that chlorine dioxide was effective in drawing out various types of oils from solid materials, including metals and terra cotta.

### Example 9: Exposing Solid Materials to Chlorine Dioxide Draws Out Fat

To investigate the ability of chlorine dioxide to draw out fat from solid materials, solid materials were soaked in fat and subsequently exposed to chlorine dioxide. The solid materials that were used were stainless steel and terra cotta. Two samples of each material (an experimental example that was subsequently subjected to fumigation and a control that was subsequently left out in the air) were soaked in ghee (clarified butter), which is an animal-derived fat. Two samples of stainless steel and two samples of terra cotta (one sample of each material served as an experimental sample and one sample as a control) were placed in a soaking container filled with ghee and soaked for 24 hours. During the soaking period, the soaking containers were placed in a 105° F. warm water bath to keep the ghee in liquid form. After the soaking period, all of the samples were removed from the container and wiped off so that no ghee could be felt or observed on the surface; the surfaces were dry to touch.

For the fumigation, a container was partially filled with 250 ml aqueous solution of approximately 2500 ppm (w/w) chlorine dioxide. A rack was placed in the container and an experimental sample of each material that had been soaked in the ghee was placed on the rack. The experimental samples did not come into contact with the solution. The container was closed so that the liquid chlorine dioxide solution would release chlorine dioxide gas into the headspace. It is estimated that approximately 7500 ppmᵥ of chlorine dioxide was released into the headspace. The container was kept in the dark for 24 hours without opening the container. The control samples were exposed to the ambient air during the 24 hour period.

After the 24 hour fumigation period, the container was opened and the samples were inspected. Bubbles of ghee appeared on the surface of the fumigated stainless steel and terra cotta samples. The control samples of both materials remained dry and did not exhibit any change in appearance.

These results show that chlorine dioxide was effective in drawing out fat from solid materials, including metal (stainless steel) and terra cotta.

1-105. (canceled)

106. A mixture suitable for introduction into a wellbore of a petroleum production well, the mixture comprising
a) water,
b) chlorine dioxide at a concentration of 100 to 10,000 ppm,
c) 0.1 to 10% xylene,
d) 0.1 to 10% citric acid, and
e) 0.1 to 5% ethylene glycol monobutyl ether (EGMBE).

107. The mixture of claim 106, comprising chlorine dioxide at a concentration of at least 500 ppm.

108. The mixture of claim 106, comprising a salt at a concentration of 0.1 to 20%.

109. The mixture of claim 106, wherein the mixture is homogeneous.

110. The mixture of claim 108, wherein the mixture is homogeneous.

111. The mixture of claim 106, wherein the mixture comprises at least 95% liquid components.

112. The mixture of claim 109, wherein the mixture comprises at least 95% liquid components.

113. The mixture of claim 110, wherein the mixture comprises at least 95% liquid components.

114. A method of treating a hydrocarbon bearing formation, the method comprising contacting the hydrocarbon bearing formation with a mixture according to claim 106.

115. A method of treating a hydrocarbon bearing formation, the method comprising contacting the hydrocarbon bearing formation with a mixture according to claim 108.

116. A method of treating a hydrocarbon bearing formation, the method comprising contacting the hydrocarbon bearing formation with a mixture according to claim 109.

117. A method of treating a hydrocarbon bearing formation, the method comprising contacting the hydrocarbon bearing formation with a mixture according to claim 113.

118. A mixture comprising
a) water,
b) chlorine dioxide at a concentration of 2500 to 3500 ppm,
c) 1 to 10% xylene,
d) 0.1 to 10% citric acid, and
e) 0.1 to 5% EGMBE.

119. The mixture of claim 118, further comprising a salt.

120. The mixture of claim 119, comprising the salt at a concentration of 0.1 to 10%.

121. The mixture of claim 118, wherein the mixture is homogeneous.

122. The mixture of claim 119, wherein the mixture is homogeneous.

123. The mixture of claim 120, wherein the mixture is homogeneous.

124. The mixture of claim 118, wherein the mixture comprises at least 95% liquid components.

125. The mixture of claim 121, wherein the mixture comprises at least 95% liquid components.

126. A method of treating a hydrocarbon bearing formation, the method comprising contacting the hydrocarbon bearing formation with a mixture according to claim 118.

127. A method of treating a hydrocarbon bearing formation, the method comprising contacting the hydrocarbon bearing formation with a mixture according to claim 119.

128. A method of treating a hydrocarbon bearing formation, the method comprising contacting the hydrocarbon bearing formation with a mixture according to claim 122.

129. A method of treating a hydrocarbon bearing formation, the method comprising contacting the hydrocarbon bearing formation with a mixture according to claim 124.

130. A method comprising combining water, chlorine dioxide, xylene,
citric acid and EGMBE to form a mixture containing at least 100 ppm chlorine dioxide, 0.1 to 10% xylene, 0.1 to 10% citric acid, and 0.1 to 5% EGMBE, the combining comprising (i) venturi mixing a first component and a second component and, concurrently or subsequently, (ii) venturi mixing a third component with the first and/or second component, wherein the first component, the second component and the third component are different and selected from water, chlorine dioxide and xylene.

131. The method of claim 130, further comprising contacting a hydrocarbon bearing formation with the mixture.

132. The method of claim 130, the combining comprising pumping water through a venturi to drive the venturi and educting chlorine dioxide and xylene into the venturi so that the chlorine dioxide and the xylene mix with the water.

133. A method comprising
(i) educting chlorine dioxide, xylene, citric acid, and EGMBE into a venturi driven by water so that the chlorine dioxide, xylene, citric acid and EGMBE mix with the water to form a mixture containing at least 200 ppm chlorine dioxide, 0.1 to 20% xylene, 0.1-20% citric acid, and 0.1 to 5% EGMBE, and
(ii) contacting a hydrocarbon bearing formation with the mixture.

134. The method of claim 133, wherein the water contains a salt at a concentration of 0.1 to 25%.

135. The method of claim 133, wherein the salt comprises potassium chloride.

136. The method of claim 133, wherein the mixture comprises at least 95% liquid components.
